(19) United States
(12) Patent Application Publication
(10) Pub. No.: US 2025/0380200 A1
(43) Pub. Date: Dec. 11, 2025

(54) SYSTEMS, METHODS, AND DEVICES FOR FAST PRIMARY CELL RECOVERY

(71) Applicant: Apple Inc., Cupertino, CA (US)

(72) Inventors: Alperen GUNDOGAN, Munich (DE); Amr Abdelrahman Yousef A. MOSTAFA, Munich (DE); Christian HOFMANN, Munich (DE); Panagiotis BOTSINIS, Munich (DE); Sameh M. ELDESSOKI, Munich (DE); Tarik TABET, Carlsbad, CA (US)

(21) Appl. No.: 18/737,860

(22) Filed: Jun. 7, 2024

(51) Int. Cl. H04W 36/30; H04W 36/00; H04W 76/20

(52) U.S. Cl. CPC H04W 36/305; H04W 36/0061; H04W 36/0072; H04W 76/20

(57) ABSTRACT

Described herein are solutions for fast primary cell (PCell) recovery using a supplementary cell (SuC) to configure a new PCell to restore a failed radio link between a user equipment (UE) and a PCell. The UE can detect a radio link failure (RLF) corresponding to the PCell and use a SuC to recover connectivity with another PCell. The UE can send PCell failure information to the SuC and, in response to the PCell failure information, the network can configure another cell to operate as a PCell for the UE. The new PCell can be a special cell (SpCell) configured with PCell configuration information, the SuC configured with PCell configuration information, or another type of cell. These and many other features and examples are described herein.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for enabling user equipment (UE) and network devices, such as base stations, to communicate with one another. Some scenarios can involve enabling a UE and network to establish and maintain a consistent connection or radio link between one another.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example of a master cell group (MCG) and a secondary cell group (SCG) according to one or more implementations described herein.

FIGS. 4-6 are diagrams of examples of network deployment implementations or scenarios according to one or more implementations described herein.

FIGS. 7-8 are diagrams of an example process for fast primary cell (PCell) recovery according to one or more implementations described herein.

FIGS. 9-11 are diagrams of an example process for fast PCell recovery via a using a supplementary cell (SuC) according to one or more implementations described herein.

FIGS. 12-14 are diagrams of an example process for fast PCell recovery via proactive radio link re-establishment according to one or more implementations described herein.

FIGS. 15-17 are diagrams of an example process for fast PCell recovery via SuC with carrier aggregation (CA) and supplementary uplink (SUL) and supplementary downlink (SDL) carriers according to one or more implementations described herein.

FIGS. 18-19 are diagrams of an example user equipment (UE) process for fast PCell recovery according to one or more implementations described herein.

FIG. 20 is a diagram of an example process for fast PCell recovery according to one or more implementations described herein.

FIG. 21 is a diagram of an example of another process for fast PCell recovery according to one or more implementations described herein.

FIG. 22 is a diagram of an example of components of a device according to one or more implementations described herein.

FIG. 23 is a diagram of example interfaces of baseband circuitry according to one or more implementations described herein.

FIG. 24 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 25 is a diagram of an example process for fast PCell recovery according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs and base stations can implement various techniques and communications standards for enabling UEs and base stations to discover one another, establish and maintain connectivity, and exchange information in an ongoing manner. Objectives of such techniques can include enabling a UE and network to establish and maintain a consistent connection or radio link between one another.

The mobility of a UE can lead to a connection or radio link failures between the UE and a base station (or other type of network access node). Radio link failures can be particularly common near the edges of a cell. In response to a radio link failure, the UE can imitate an RRC Connection Reestablishment procedure. In a single connectivity scenario, the UE is only connected to a single base station or cell. As such, the RRC Reestablishment procedure can be directed toward the same base station that just experienced the radio link failure. As such, the RRC Reestablishment procedure can involve additional time, greater latencies, and other deficiencies or failures.

In a dual connectivity scenario, a UE can be connected to a network via multiple cells or base stations. For example, a UE can have a radio link with one base station operating as a primary cell (PCell) and have another radio link with another base station operating as a secondary cell (SCell). In the event of a radio link failure involving the PCell, the UE can respond by performing suitable PCell selection, initiating the RRC Reestablishment procedure, and completing security authentications involving a target special cell (SpCell). In scenarios involving a master cell group (MCG) failure (PCell) or secondary cell group (SCG) failure (PSCell), there can be mechanisms to recover the connectivity using the other leg of the dual connectivity scenario.

One or more of the techniques described herein can include solutions to fast PCell recovery by using a SuC to promptly configure a new PCell for the UE and restore a failed radio link between the UE and the previous PCell. The SuC can become a new PCell for the UE. In some implementation, the SuC can enable a target SpCell to become a new PCell for the UE. The SuC can be co-located with the new PCell and use supplementary downlink (SDL) carriers and supplementary uplink (SUL) carriers to operate in the capacity of an SuC. Co-located can refer to RAN nodes (e.g., base stations) that are different physical devices located close to one another. Co-located can also, or alternatively, refer to a single RAN node that is configured to operate as different types of cells (e.g., a PCell and an SuC).

In some implementations, the SuC can be an SCell configured to use carrier aggregation (CA) to provide SuC functionality. A SuC co-located with a PCell can be configured to use SDL carriers and SUL carriers to provide SuC functionality to a UE, and an SCell can be configured to use CA to provide SuC functionality to the UE. In such implementations, the UE can determine whether to use the CA of the SCell, or the SDL and SUL carriers of the SuC, to recover from a radio link failure with a PCell. The techniques described herein can enhance a quality of experience of UEs during mobility by reducing the service interruption time in case of radio link failure. Further, even when a UE or network does not support fast PCell recovery procedure, the UE can fall back to legacy radio resource control (RRC) reestablishment procedures. As such, the techniques described herein not only provide many solutions for fast PCell recovery, but the solutions provided can be implemented without eliminating or diminishing existing alternatives for PCell recovery.

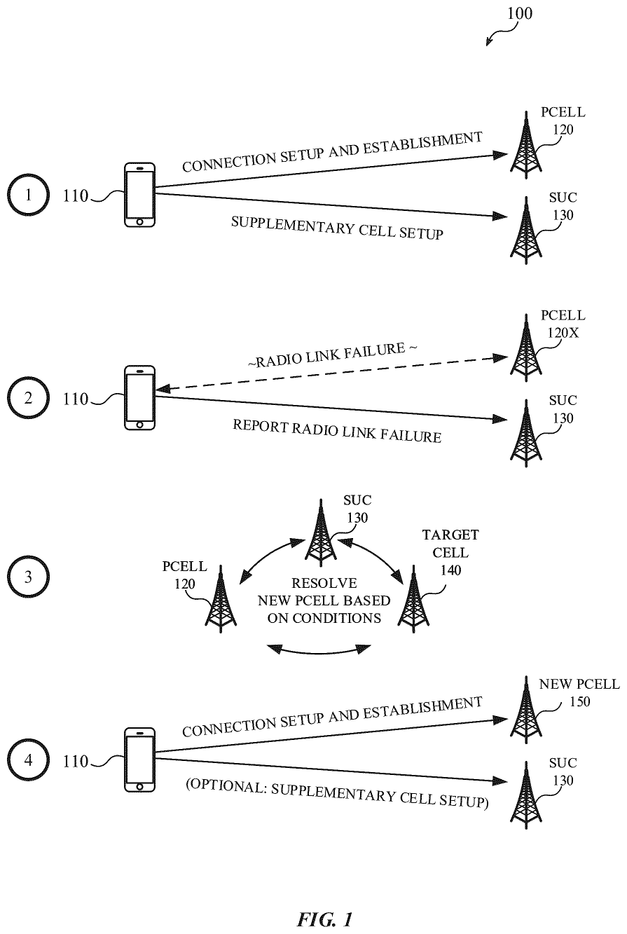

FIG. 1 is a diagram of an example of an overview 100 according to one or more implementations described herein. As shown, overview 100 can include UE 110, PCell 120, SuC 130, target cell 140, and new PCell 150. PCell 120, SuC 130, target cell 140, and new PCell 140 can each be implemented by one or more base stations and/or another type of network access node. In some implementations, each of PCell 120, SuC 130, target cell 140, and new PCell 150 can be implemented as different base stations. In some implementations, one or more of PCell 120, SuC 130, target cell 140, and new PCell 150 can be implemented by the same base station.

UE 110 can establish a first radio link with PCell 120 and a second radio link with SuC 130 (at 1). UE 110 can detect a radio link failure (RLF) corresponding to PCell 120, and in response to the failure, can send PCell failure information to SuC 130 (at 2). In response, devices of the network can communicate in one or more ways to designate and configure another cell to operate as a new PCell for UE 110 (at 3). Examples of the network devices can include PCell 120, SuC 130, target cell 140, and/or one or more other network devices.

Depending on the implementation or scenario, new PCell 140 can be an SpCell configured with PCell configuration information; SuC 130 configured with PCell configuration information; or another type of cell. New PCell 140 and UE 110 can then communicate with one another to establish a new radio link to replace the failed radio link. When SuC 130 becomes new PCell 140, another base station can be configured to operate as a new SuC for UE 110. UE 110 can communicate with the new PCell 140 (and/or a new SuC) to restore radio links between UE 110 and the network (at 4). These features and many other examples and aspects of the techniques described herein are presented with additional context and detail below.

As described herein, a primary radio link can include a connection or radio link between a UE and a base station that is providing PCell services to the UE. A supplementary radio link can include a connection or radio link between a UE and a base station that is providing SuC services to UE 210. SuC services can include SUL resources and/or SDL resources allocated for communications between a UE and an SuC. The SuC services can also, or alternatively, include supplementary connectivity provided to UE by an SCell via CA. A SuC can refer to a base station configured to provide supplementary connectivity and services via SUL and/or SDL. An SuC can also, or alternatively, refer to a base station (e.g., an SCell) configured to provide supplementary connectivity to a UE and services via CA.

An SuC can be a base station operating as an SCell for a UE, and SUL and/or SDL resources can be implemented using CA. SUL and/or SDL resources can be allocated to UE via a configuration grant from a PCell or a random access channel (RACH) procedure with SuC. A PCell can configure SuC to provide fast PCell recovery services to a UE in response to receiving a request from the UE for fast PCell recovery services. Fast PCell recovery services, as referred to herein, can include one or more of the processes, operations, and/or techniques described herein as enabling fast PCell recovery. Examples of fast PCell recovery and fast PCell recovery services are described below in detail.

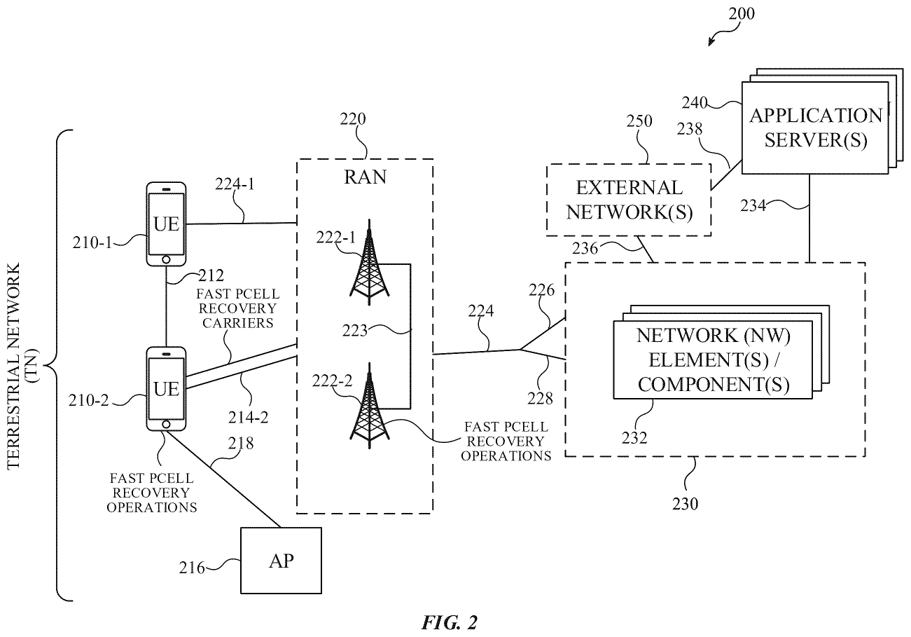

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network node 222.

As described herein, UE 210 can receive and store one or more configurations, instructions, and/or other information for enabling SL-U communications with quality and priority standards. A PQI can be determined and used to indicate a QoS associated with an SL-U communication (e.g., a channel, data flow, etc.). Similarly, an LI priority value can be determined and used to indicate a priority of an SL-U transmission, SL-U channel, SL-U data, etc. The PQI and/or LI priority value can be mapped to a CAPC value, and the PQI, LI priority, and/or CAPC can indicate SL channel occupancy time (COT) sharing, maximum (MCOT), timing gaps for COT sharing, LBT configuration, traffic and channel priorities, and more.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 216 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, cNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 can operate using stand-alone unlicensed operation, licensed assisted access (LAA), cLAA, and/or feLAA mechanisms. In these implementations, UEs 210 and the RAN nodes 222 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

One or more of the techniques, described herein, can enable fast PCell recovery by using a SuC to rapidly configure the new PCell and restore the radio link. UE 210 can have a first radio link with a PCell and a second radio link with a SuC. UE 210 can detect an RLF corresponding to the PCell, and in response to the failure, can use the SuC to recover connectivity. That is, UE 210 can send PCell failure information to the SuC and, in response to the PCell failure information, the network can configure another cell to operate as a PCell for the UE. Depending on the scenario, the new PCell can be an SpCell configured with PCell configuration information, the SuC configured with PCell configuration information, or another type of cell. The new PCell and UE 210 can then communicate with one another to establish a new radio link to replace the failed radio link. These and other features and examples are described herein with additional context and detail below.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more cNBs/gNBs or a combination thereof) that connect to evolved packet core (EPC) or CN 230, or between two cNBs connecting to an EPC. In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (ScNB); information about successful in sequence delivery of PDCP packet data units (PDUs) to a UE 210 from an ScNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 can also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

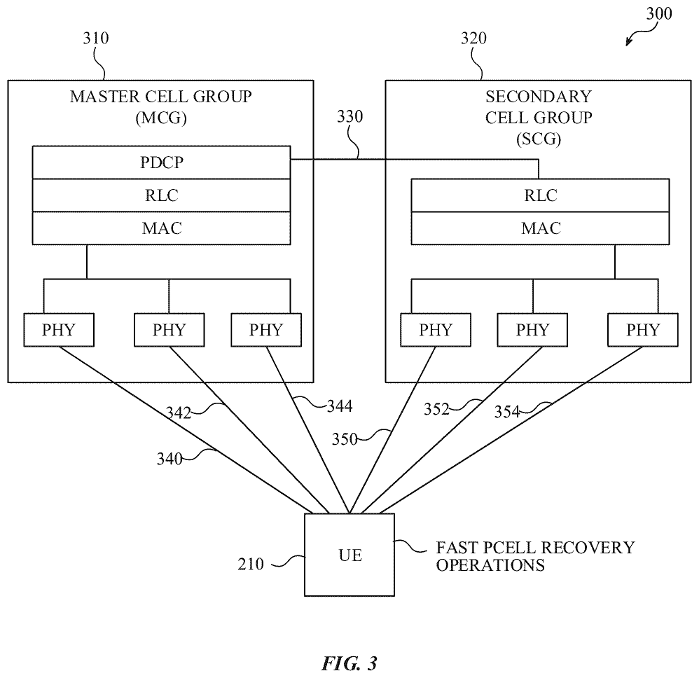

FIG. 3 is a diagram of an example 300 of a master cell group (MCG) 310 and a secondary cell group (SCG) 320 according to one or more implementations described herein. An MCG can include a group of cells associated with a master node, comprising a PCell and one or more SCells. An SCG can include a group of serving cells associated with a secondary node, comprising a primary cell of the secondary cell group (PSCell) and optionally one or more SCells. MCG 310 and SCG 320 can each be implemented by one or more base station 222 and/or another type of RAN node or access point.

MCG 310 can be implemented by one or more base stations and can include one or more layers. Examples of such layers can include a PDCP layer, an RLC layer, a MAC layer, and multiple PHY layers. Each PHY layer can correspond to a different implementation of a cell with respect to UE 210. Additionally, or alternatively, the PHY layers can operate in combination (e.g., be managed, controlled by, etc.) the PDCP, RLC, and MAC layers. In some implementations, one PHY layer 340 can operate as a PCell or a special cell (SpCell) and other PHY layers 342 and 344 can operate as SCells to the PCell.

SCG 320 can include multiple layers as well, including an RLC layer, a MAC layer, and multiple PHY layers 350, 352, and 354. SCG 320 may not include a PDCP layer, but instead can rely on the PDCP layer of MCG 310 via connection 330. Similar to the PHY layers of MCG 310, the PHY layers of SCG 320 can each function or operate as a cell with respect to UE 210. In some implementations, one PHY layer 350 can operate as a primary cell (PCell) to PHY layers 352 and 354, which can operate as secondary cells to the PCell of PHY layer 350. Additionally, MCG 310 and SCG 320 can each include a PCell (e.g., 340 and 350), and a PCell can be referred to herein as a special cell or special primary cell, represented as SpCell. Further, a SCell, of either MCG 310 or SCG 320, can operate as a scheduling secondary cell (sSCell) configured to provide configuration, scheduling, activation, deactivation, and other functions or commands toward a SpCell of either MCG 310 or SCG 320.

MCG 310 and SCG 320 can be involved in a dual connectivity scenario with UE 210, in which case a random access channel (RACH) procedure, and the like, can be directed to MCG 310. MCG 310 and SCG 320 can also implement a standalone (SA) and/or a non-standalone (NSA) network environment for UE 210. In a SA network environment, MCG 310 and SCG 320 can communicate with UE 210 using 5G NR communication standards. In an NSA network environment, MCG 310 and SCG 320 can communicate with UE 210 using a combination of 4G LTE and 5G NR communication standards. MCG 310 and/or SCG 320 can be configured to enable, support, and/or operate in accordance with the techniques described herein for signaling and procedure for communications via a UL-only TRP. For example, one or more of the techniques described herein can include solutions for scenarios in which a macro cell (e.g., a base station 222 operating as an MCG or PCell with respect to UE 210) causes or enables UL-only communications via another base station 222 that is operating as a SCG or SCell.

One or more of the techniques described herein can be implemented to enabling fast PCell recovery by using a SuC to rapidly configure the new PCell and restore the radio link. An SuC, as described herein, can be a PCell, SCell, and/or another type of network access node that is configured with one or more SULs and/or SDLs to enable fast PCell recovery for a particular UE 210. An SuC can be used for transmitting and receiving control information and user information (e.g., data packets) in addition to supporting fast PCell recovery as described herein.

UE 210 can have a first radio link with a PCell and a second radio link with a SuC. UE 210 can detect an RLF corresponding to the PCell, and in response to the failure, can use the SuC to recover connectivity. That is, UE 210 can send PCell failure information to the SuC and, in response to the PCell failure information, the network can configure another cell to operate as a PCell for the UE. Depending on the scenario, the new PCell can be an SpCell configured with PCell configuration information, the SuC configured with PCell configuration information, or another type of cell (e.g., SpCell). The new PCell and UE 210 can then communicate with one another to establish a new radio link to replace the failed radio link. These and other features and examples are described herein with additional context and detail below.

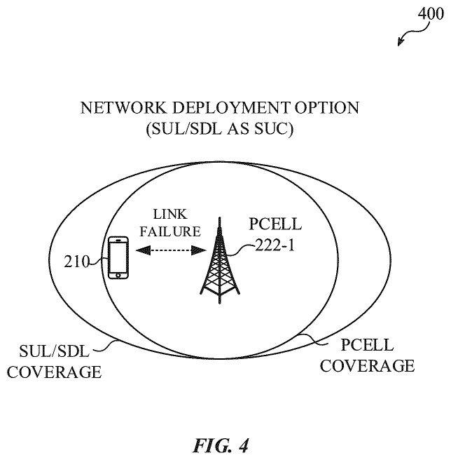

FIGS. 4-6 are diagrams of examples of network deployment implementations or scenarios 400-600 according to one or more implementations described herein. As shown in FIG. 4, example 400 includes UE 210 and PCell 222-1 (which can be implemented by a base station). PCell 210 can have a default of typical coverage area (represented as a PCell coverage). PCell 210 can also configure SUL and SDL carriers to enable PCell 210 to operate as an SuC for UE 210. The SUL and SDL carriers can define a coverage area for the SuC (e.g., an SUL/SDL coverage area). The SuC can be implemented by the same base station as PCell 210. SuC can also be implemented by another base station co-located with PCell 210. A radio link failure between UE 210 and PCell 222-1 can trigger a fast PCell recovery procedure as described herein.

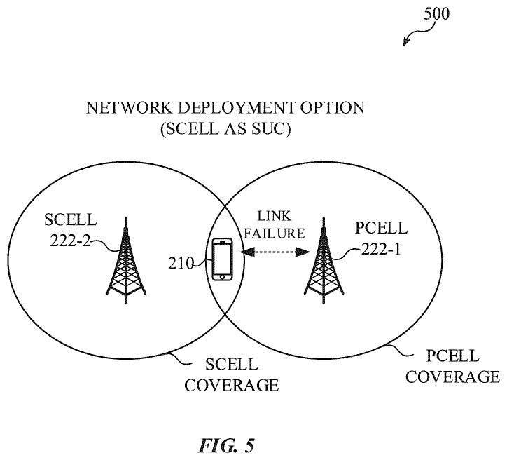

As shown in FIG. 5, example 500 can include UE 210, PCell 222-1, and SCell 222-2. PCell 222-1 and SCell 222-2 can be implemented by base stations at different locations with different but overlapping coverage areas. Carrier aggregation can be used to configured SCell 222-2 to operate as an SuC for UE 210. A radio link failure between UE 210 and PCell 222-1 can trigger a fast PCell recovery procedure as described herein.

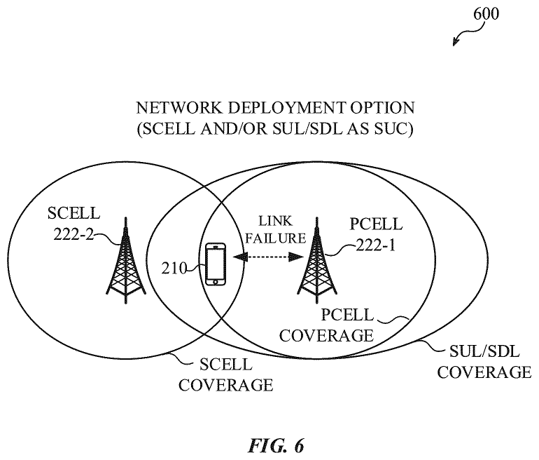

As shown in FIG. 6, example 600 can include UE 210, PCell 222-1, and SCell 222-2. PCell 222-1 and SCell 222-2 can be implemented by base stations at different locations with different but overlapping coverage areas. PCell 210 can have a default of typical coverage area (represented as a PCell coverage). PCell 210 can also configure SUL and SDL carriers to enable PCell 210 to operate as an SuC for UE 210. The SUL and SDL carriers can define a coverage area for the SuC (e.g., an SUL/SDL coverage area). Additionally, or alternatively, carrier aggregation can be used to configured SCell 222-2 to operate as an SuC for UE 210 via one or more SULs and/or SDLs. In some implementations, the network can determine whether PCell 222-1 or SCell 222-2 is to operate an SuC for UE 210. Additionally, or alternatively, UE 210 can determine whether PCell 222-1 or SCell 222-2 is to operate an SuC. A radio link failure between UE 210 and PCell 222-1 can trigger a fast PCell recovery procedure as described herein.

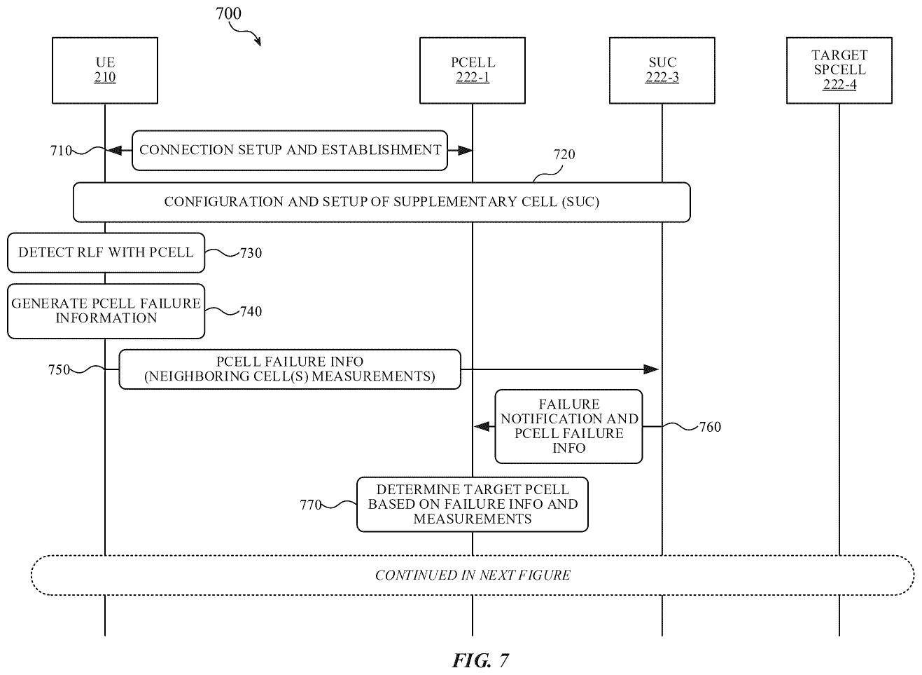

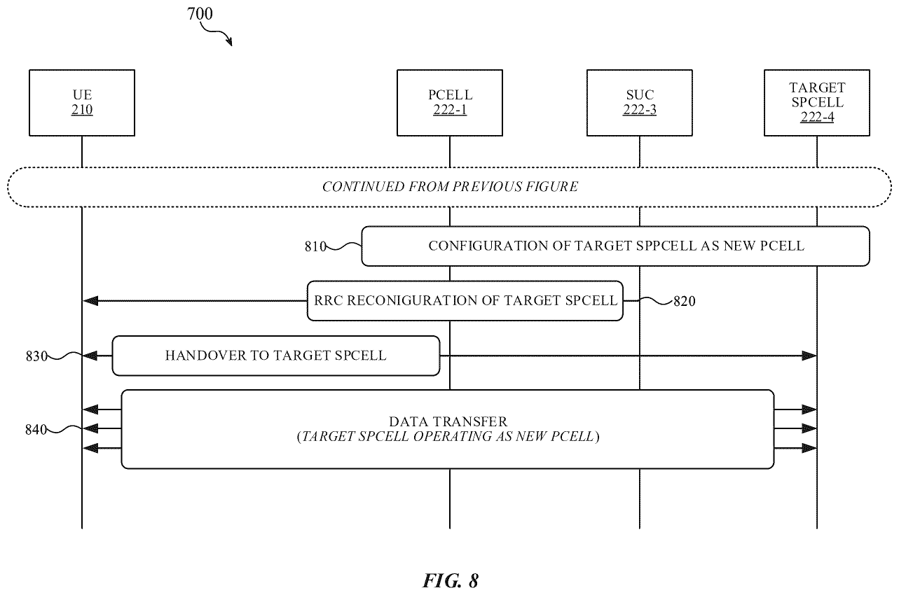

FIGS. 7-8 are diagrams of an example of a process 700 for fast PCell recovery according to one or more implementations described herein. Process 700 can be implemented by UE 210, PCell 222-1, SuC 222-3, and target SpCell 222-4. PCell 222-1, SuC 222-3, and/or target SpCell 222-4 can be implemented by one or more base station 222, which can or may not involve an MCG 310 and/or SCG 320. SpCell 222-4 can be an SCell to UE 210.

In some implementations, some or all of process 700 can be performed by one or more other systems or devices, including one or more of the systems or devices of FIGS. 2-6. Additionally, process 700 can include one or more fewer, additional, differently ordered and/or arranged operations than those shown in FIGS. 7-8. Some or all of the operations of process 700 can be performed independently, successively, simultaneously, etc., of one or more of the other operations of process 700. Further, one or more of the operations of process 700 can include one or more of the features, conditions, information, characteristics, etc., described elsewhere herein. As such, the techniques described herein are not limited to the number, sequence, arrangement, timing, type, etc., of the operations or processes depicted in FIGS. 7-8.

As shown, process 700 can include UE 210 communicating with PCell 222-1 to setup and establish a connection or radio link that enables UE 210 and PCell 222-1 to communicate with one another (block 710). This can include one or more types of RACH procedures, allocations of time and frequency resources, one or more types of messages, and the use of one or more types of UL and/or DL channels. Process 700 can also include UE 210, PCell 222-1, and/or another cell communicating with one another to setup and configured the other cell to operate as SuC 222-3 for UE 210 (block 720).

In some implementations, SuC 222-3 can be co-located with PCell 222-1 and use SDL carriers and SUL carriers to operate in the capacity of an SuC with respect to UE 210. Co-located can refer to PCell 222-1 and SuC 222-3 being different physical devices located within a proximity threshold of one another (e.g., close enough to potentially cause radio interference when communicating with UE 210). Co-located can also, or alternatively, refer to a single RAN node that is configured to operate as different types of cells with respect to UE 210 (e.g., a PCell and an SuC). When SuC 222-3 is co-located with PCell 222-1, SuC 222-3 can be configured to use lower frequencies for UL and DL signaling than PCell 222-1.

In some implementations, SuC 222-3 can be an SCell configured to use CA to provide SuC functionality to UE 210. While not shown in FIG. 7, in implementations, SuC services can be available to UE 210 from an SUC co-located with PCell 222-1 and from an SCell configured to use CA to provide SuC functionality to UE 210. In such implementations, UE 210 can determine whether to use the CA of the SCell, or the SDL and SUL carriers of the SuC, to recover from a radio link failure with a PCell.

Process 700 can include UE 210 detecting an RLF corresponding to PCell 222-1 (block 730). For example, UE 210 can monitor a strength, quality, reliability, latency, and/or one or more other types of link-related characteristics with respect to PCell 222-1. UE 210 can compare the monitored or measured characteristics with one or more link-related thresholds and determine that a radio link between UE 210 and PCell 222-1 has failed when the measured characteristic(s) breach the designated threshold(s).

Process 700 can include UE 210 generating PCell failure information (block 740). For example, in response to detecting a RLF between UE 210 and PCell 222-1, UE 210 can produce information related to the radio link, the failure of the radio link, PCell 222-1, UE 210, and more. PCell failure information can include one or more types and/or combinations of a variety of information that can be used to enable fast PCell recovery as described herein. PCell failure information can include signal measurements relating to one or more other cells (e.g., neighboring cells) in the area. In some implementations, the PCell failure information can include measurements of SuC 222-3. Additional examples of PCell failure information can include bearer information, cell group ID, logical channel identity, etc. PCell failure information can also be referred to a RLF information.

Process 700 can also include UE 210 communicating the PCell failure information to SuC 222-3 (block 750). For example, UE 210 can determine that a signal strength between UE 210 and SuC 222-3 is remains viable despite the RLF with PCell 222-1. As such, instead of initiating an RRC reestablishment procedure with PCell 222-1, UE 210 can send PCell failure information to SuC 222-3. UE 210 can the send PCell failure information using the lower frequencies of the SUL resources as opposed to the higher frequencies allocated for signaling PCell 222-1. The PCell failure information can include an indication of a radio link quality between UE 210 and SuC 222-3, between UE 210 and an SCell, between UE 210 and target SpCell, and/or between UE 210 and one or more other types of neighboring cells. s

When SuC services are provided to UE 210 via a SuC using SUL and SDL careers and a SCell using CA, UE 210 can determine whether to send the PCell failure information to the SuC (e.g., via an SUL carrier) or the SCell. In some implementations, UE 210 can make this determination by measuring a signal strength from each network node, comparing the signal strengths, and communicating the PCell failure information to the network node with the higher signal strength. In some implementations, UE 210 can make this determination based on one or more additional, and/or alternative, factors, conditions, or parameters. Additionally, or alternatively, when UE 210 determines that a radio link with SuC 222-3 has also failed, UE 210 can initiate RRC reestablishment procedure with PCell 222-1 or a RACH procedure with another base station 222.

Process 700 can include SuC 222-3 communicating a failure notification and the PCell failure information to PCell 222-1 (block 760). For example, SuC 222-3 can receive the PCell failure information from UE 210. In response, SuC 222-3 can generate a failure message or notification relating to the RLF between UE 210 and PCell 222-1. SuC 222-3 can also communicate the failure message and the PCell failure information to PCell 222-1. In some implementations, the PCell failure information can function as the failure message or notification.

Process 700 can also include PCell 222-1 determining a target PCell based on the PCell failure information (block 770). For example, PCell 222-1 can receive the failure notification and PCell failure information from SuC 222-3. As described, the PCell failure information can include signal strength measurements and identification information corresponding to one or more cells in the area (e.g., SuC 222-3, target SpCell 222-4, and other neighboring cells). PCell 222-1 can evaluate the PCell failure information to determine a target cell for becoming a new PCell for UE 210. In some implementations, PCell 222-1 can identify a target PCell based other information, such as a preferred target cell ID indicated in PCell failure information.

Referring to FIG. 8, process 700 can include configuring target SpCell 222-4 as the new PCell (block 810). For example, assume that PCell 222-1 identified target SpCell 222-4 to be the new PCell for UE 210. In response, PCell 222-1 can provide target SpCell 222-4 with a prompt, instructions, and configuration information to enable target SpCell 222-4 to operate as the PCell for UE 210. Examples of information that PCell can provide target SpCell 222-4 can include RRC reconfiguration information, or other information, such as UE context information, PCell failure information, etc. In some implementations, this can include information to cause or enable target SpCell 222-4 to participate in a handover procedure that involves UE 210 transitioning from PCell 222-1 to target SpCell 222-4. Target SpCell 222-4 can also provide PCell 222-1 with one or more types of information. Examples of information that SpCell 222-4 can provide PCell 222-1 can include an indication to PCell 222-1 a connection request has been rejected by UE 210 or has otherwise failed. This can prompt PCell 222-1 to identify and configure another target cell to become a PCell for UE 210.

Process 700 can also include SuC 222-3 sending a message to UE 210 about the configuration of target SpCell 222-4 (block 820). For example, SuC 222-3 can send UE 210 an RRC reconfiguration information that identifies target SpCell 222-4, identifies resources for communicating with target SpCell 222-4, and/or prompts UE 210 to engage in a handover procedure from PCell 222-1 to target SpCell 222-4. As such, process 700 can include UE 210 and target SpCell 222-4 communicating to perform a handover procedure (block 830). As a result, target SpCell 222-4 can operate as the new PCell for UE 210, such that network connectivity is restored and UE 210 and target SpCell 222-4 can engage in one or more types of data transfers going forward (block 840).

While not shown, in some implementations, PCell 222-1 can identify SuC 222-3 (instead of target SpCell 222-4) as the appropriate cell to become the new PCell. For example, when the measurements from UE 210 or other PCell failure information indicates that a signal strength of SuC 222-3 is greater than a signal strength threshold, is superior to a measured signal strength of target SpCell 222-4, etc., PCell 222-1 can determine that SuC 222-3 is to be the new PCell for UE 210. In such scenarios, PCell 222-1 can configure SuC 222-3 to become the new PCell, and SuC 222-3 can send an RRC reconfiguration message to UE 210 prompting a handover procedure toward SuC 222-3, such that SuC 222-3 becomes the new PCell. The RRC reconfiguration information can be provide to UE 210 by PCell 222-1 or SuC 222-3.

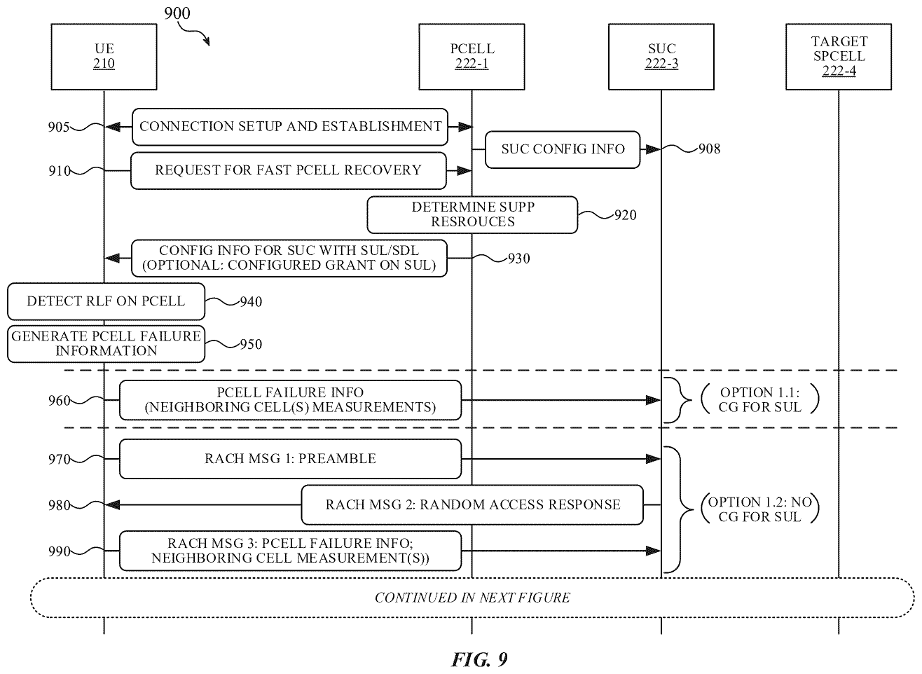

FIGS. 9-11 are diagrams of an example process 900 for fast PCell recovery via a using a SuC according to one or more implementations described herein. Process 900 can be implemented by UE 210, PCell 222-1, SuC 222-3, and target SpCell 222-4. PCell 222-1, SuC 222-3, and/or target SpCell 222-4 can be implemented by one or more base station 222, which can or may not involve an MCG 310 and/or SCG 320. In some implementations, some or all of process 900 can be performed by one or more other systems or devices, including one or more of the systems or devices of FIGS. 2-6. Additionally, process 900 can include one or more fewer, additional, differently ordered and/or arranged operations than those shown in FIGS. 9-11. Some or all of the operations of process 900 can be performed independently, successively, simultaneously, etc., of one or more of the other operations of process 900. Further, one or more of the operations of process 900 can include one or more of the features, conditions, information, characteristics, etc., described elsewhere herein. As such, the techniques described herein are not limited to the number, sequence, arrangement, timing, type, etc., of the operations or processes depicted in FIGS. 9-11.

As shown, process 900 can include UE 210 communicating with PCell 222-1 to setup and establish a connection or radio link that enables UE 210 and PCell 222-1 to communicate with one another (block 905). This can include one or more types of RACH procedures, allocations of time and frequency resources, one or more types of messages, and the use of one or more types of UL and/or DL channels. As shown, process 900 can include UE 210 communicating a request to PCell 222-1 for fast PCell recovery (block 910).

Process 900 can also include PCell 222-1 communicating SuC configuring information to SuC 222-3 (block 908). For example, PCell 222-1 can determine and communicate UL and DL resources to enable SuC 222-3 to provide supplementary connectivity services to UE 210. The resource can include SUL and SDL resources when SuC 222-3 operates as an SuC. When operating as a SCell, the UL and DL resources can be implemented via CA. In some implementations, PCell 222-1 can configure SuC 222-3 to provide fast PCell recovery services to UE 210 in response to receiving a request from UE 210 for fast PCell recovery services. Fast PCell recovery services, as referred to herein, can include one or more of the processes, operations, and/or techniques described herein as enabling fast PCell recovery.

Process 900 can include PCell 222-1 determining supplementary resources for fast PCell recovery (block 920). The supplementary resources can be SUL and SDL resources or UL and DL resources can be implemented via CA. The supplementary resources can use lower frequencies for UL and DL signaling than frequencies used by PCell 222-1 for UL and DL signaling. This may, for example, increase a coverage area for supplementary communications, help prevent path loss, reduce the risk of signal interference, and more. In some implementations, the use of lower frequencies can be limited to supplementary resources for UL signaling.

Process 900 can also include PCell 222-1 communicating configuration information for supplementary cell services via SUL and/or SDL resources (block 930). In some implementations, the configuration information can include a configured grant for communicating with SuC 222-3. In some implementations, the configuration information does not include a configured grant but can include other information to enable fast PCell recovery as described herein, such as information indicating or identifying SuC 222-3 for supplementary cell services.

Process 900 can include UE 210 detecting an RLF corresponding to PCell 222-1 (block 940). For example, UE 210 can monitor a strength, quality, reliability, latency, and/or one or more other types of link-related characteristics with respect to PCell 222-1. UE 210 can compare the monitored or measured characteristics with one or more link-related thresholds and determine that a radio link between UE 210 and PCell 222-1 has failed when the measured characteristic(s) breach the designated threshold(s).

Process 900 can include UE 210 generating PCell failure information (block 950). For example, in response to detecting a RLF between UE 210 and PCell 222-1, UE 210 can produce information related to the radio link, the failure of the radio link, PCell 222-1, UE 210, and more. PCell failure information can include one or more types and/or combinations of a variety of information that can be used to enable fast PCell recovery as described herein. PCell failure information can include signal measurements relating to one or more other cells (e.g., neighboring cells) in the area. PCell failure information can also be referred to a RLF information.

Referring to Option 1.1 of FIG. 9, when a configured grant is provided, process 900 can include UE 210 using the SUL resources of the configured grant to send the PCell failure information to SuC 222-3 (block 960). Referring to Option 1.2 of FIG. 9, when a configured grant is not provided, UE 210 can perform a random access procedure directed at SuC 222-3 and send the PCell failure information to SuC 222-3 using UL resources resulting from the random access procedure. For example, in accordance with the configuration information received from PCell 222-1, UE 210 can send a RACH preamble message (msg 1) to SuC 222-3 (block 970). In some implementations, UE 210 can also, or alternatively, determine the RACH configuration for SuC 222-3 based on system information blocks (SIBs) from SuC 222-3. SuC 222-3 can respond to UE 210 by sending a random access response message (e.g., a RACH message 2 (msg 2)) (block 980). And UE 210 can send SuC 222-3 a RACH message 3 (msg 3) that includes PCell failure information (block 990). The PCell failure information can include signal strength measurements of neighboring cells (e.g., target SpCell) and/or a signal strength measurement of SuC 222-3.

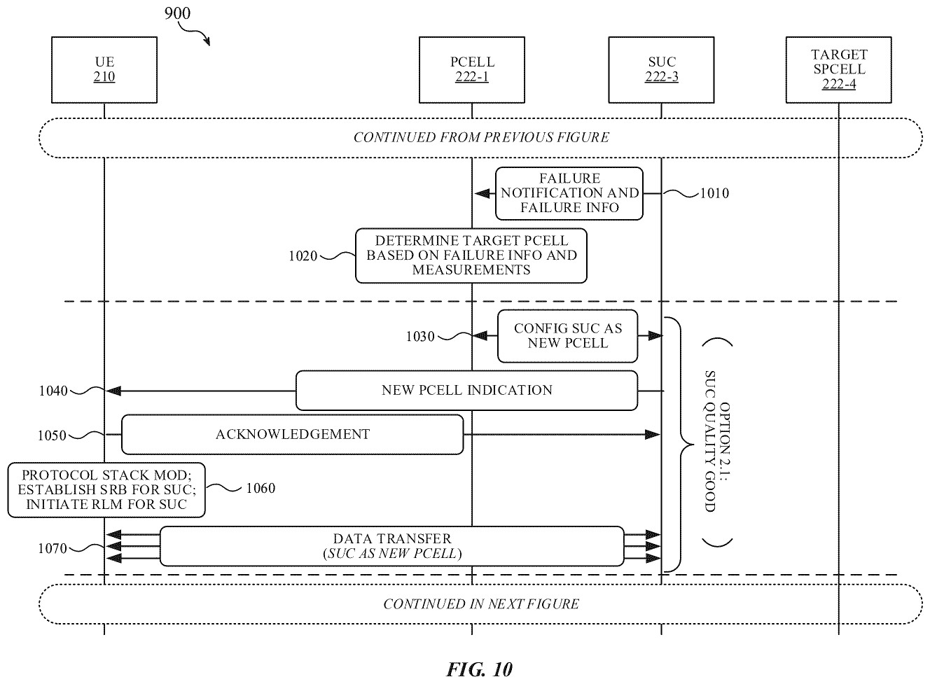

Referring to FIG. 10, process 900 can include SuC 222-3 communicating a failure notification and the PCell failure information to PCell 222-1 (block 1010). For example, SuC 222-3 can receive the PCell failure information from UE 210. In response, SuC 222-3 can generate a failure message or notification relating to the RLF between UE 210 and PCell 222-1. SuC 222-3 can also communicate the failure message and the PCell failure information to PCell 222-1. In some implementations, the PCell failure information can be or function as the failure message or notification.

Process 900 can also include PCell 222-1 determining a target PCell based on the PCell failure information (block 1020). For example, PCell 222-1 can receive the failure notification and PCell failure information from SuC 222-3. As described, the PCell failure information can include signal strength measurements and identification information corresponding to one or more cells in the area (e.g., neighboring cells), including SuC 222-3 and target SpCell 222-4. PCell 222-1 can evaluate the PCell failure information to determine a target cell for becoming a new PCell for UE 210.

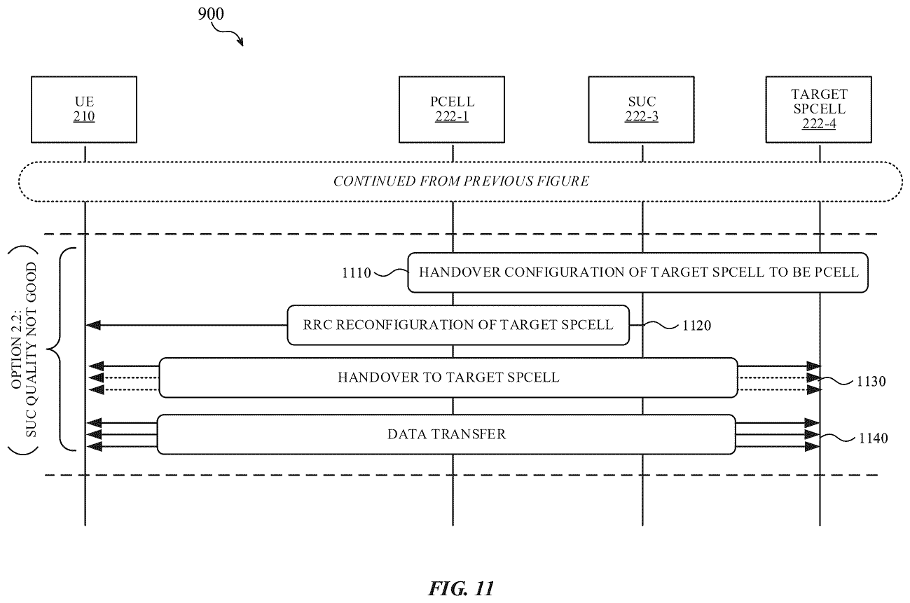

PCell 222-1 can configure SuC 222-3 or target SpCell 222-4 based on a measured signal quality or signal strength between UE 210 and SuC 222-3, UE 210 and target SpCell 222-4, or a combination thereof (Option 2.1 of FIG. 10 and Option 2.2 of FIG. 11). For example, when a link quality of SuC 222-3 is greater than a link quality threshold, and/or when the link quality of SuC 222-3 is greater than a link quality of SpCell 222, PCell 222-1 can communicate with SuC 222-3 to cause or configure SuC 222-3 to operate as the new PCell for UE 210 (block 1030, Option 2.1). This can include establishing signaling radio bearers (SRBs) to enable SuC 222-3 to communicate with UE 210, configuring SuC 222-3 for radio link monitoring (RLM) regarding links between SuC 222-3 and UE 210, and more.

Process 900 can also include SuC 222-3 sending UE 210 an indication that SuC 222-3 is to operate as the new PCell for UE 210 (block 1040). The indication can include configuration information for SRBs, RLM, and more. Process 900 can also include UE 210 receiving the indication and respond to SuC 222-3 with an acknowledgement message (block 1050). Process 900 can include UE 210 updating a protocol stack or creating a new protocol stack for communicating with SuC 222-3 as the new PCell (block 1060). UE 210 can also establish one or more SRBs and implement RLC with respect to SuC 222-3 as the new PCell. Process 900 can also include SuC 222-3 operating as the new PCell for UE 210, such that network connectivity is recovered and UE 210, and SuC 222-3 and UE 210 engaging in data transfers going forward (block 1070).

Referring to FIG. 11, as mentioned above, PCell 222-1 can determine that target SpCell 222-4 is to be the new PCell based on a measured signal quality or signal strength between UE 210 and SuC 222-3, UE 210 and target SpCell 222-4, or a combination thereof (Option 2.2). For example, when a link quality of SuC 222-3 is less than a link quality threshold, when a link quality of SpCell 222-4 is greater than a link quality threshold, and/or when the link quality of SpCell 222-4 is greater than a link quality of SuC 222-3, PCell 222-1 can configure of SuC 222-3 and/or SpCell 222-4 for a handover procedure between UE 210 and SpCell 222-4 (block 1110). PCell 222 can provide SuC 222-3 and/or SpCell 222-4 with configuration information that identifies SpCell 222-4 and/or UE 210 for a handover procedure.

Process 900 can also include SuC 222-3 generating RRC reconfiguration information for the handover procedure toward SpCell 222-4 and can communicating the RRC reconfiguration information to UE 210 (block 1120). For example, SuC 222-3 can send UE 210 an RRC reconfiguration information that identifies target SpCell 222-4, identifies resources for communicating with target SpCell 222-4, and/or prompts UE 210 to initiate a handover procedure from toward target SpCell 222-4. As such, process 900 can include UE 210 and target SpCell 222-4 communicating to perform a handover procedure (block 1130). As a result, target SpCell 222-4 can operate as the new PCell for UE 210, such that network connectivity is restored and UE 210 and target SpCell 222-4 can engage in one or more types of data transfers going forward (block 1140).

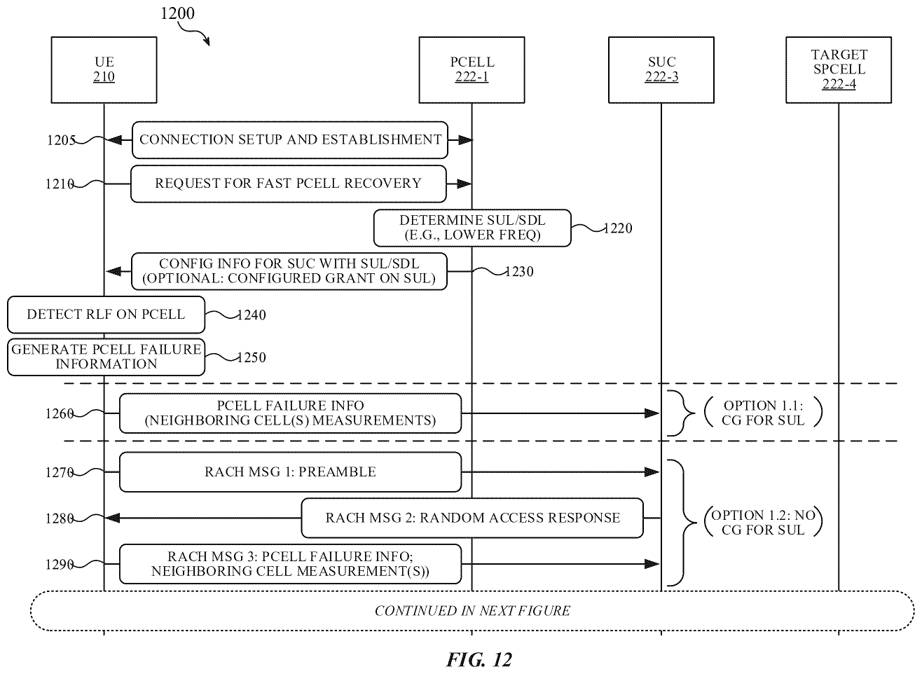

FIGS. 12-14 are diagrams of an example process 1200 for fast PCell recovery via proactive radio link re-establishment according to one or more implementations described herein. Process 1200 can be implemented by UE 210, PCell 222-1, SuC 222-3, and target SpCell 222-4. PCell 222-1, SuC 222-3, and/or target SpCell 222-4 can be implemented by one or more base station 222, which can or may not involve an MCG 310 and/or SCG 320. In some implementations, some or all of process 1200 can be performed by one or more other systems or devices, including one or more of the systems or devices of FIGS. 2-6. Additionally, process 1200 can include one or more fewer, additional, differently ordered and/or arranged operations than those shown in FIGS. 12-14. Some or all of the operations of process 1200 can be performed independently, successively, simultaneously, etc., of one or more of the other operations of process 1200. Further, one or more of the operations of process 1200 can include one or more of the features, conditions, information, characteristics, etc., described elsewhere herein. As such, the techniques described herein are not limited to the number, sequence, arrangement, timing, type, etc., of the operations or processes depicted in FIGS. 12-14.

As shown, process 1200 can include UE 210 communicating with PCell 222-1 to setup and establish a connection or radio link that enables UE 210 and PCell 222-1 to communicate with one another (block 1205). This can include one or more types of RACH procedures, allocations of time and frequency resources, one or more types of messages, and the use of one or more types of UL and/or DL channels. As shown, process 1200 can include UE 210 communicating a request to PCell 222-1 for fast PCell recovery (block 1210).

Process 1200 can also include PCell 222-1 communicating SuC configuring information to SuC 222-3 (block 1208). For example, PCell 222-1 can determine and communicate UL and DL resources to enable SuC 222-3 to provide supplementary connectivity services to UE 210. The resource can include SUL and SDL resources when SuC 222-3 operates as an SuC. When operating as a SCell, the UL and DL resources can be implemented via CA.

Process 1200 can include PCell 222-1 determining supplementary resources for fast PCell recovery (block 1220). The supplementary resources can be SUL and SDL resources, or UL and DL resources can be implemented via CA. The supplementary resources can use lower frequencies for UL and DL signaling than frequencies used by PCell 222-1 for UL and DL signaling. This may, for example, increase a coverage area for supplementary communications, help prevent path loss, reduce the risk of signal interference, and more. In some implementations, the use of lower frequencies can be limited to supplementary resources for UL signaling.

Process 1200 can also include PCell 222-1 communicating configuration information for supplementary cell services via SUL and/or SDL resources (block 1230). In some implementations, the configuration information can include a configured grant for communicating with SuC 222-3. In some implementations, the configuration information does not include a configured grant but can include other information to enable fast PCell recovery as described herein, such as information indicating or identifying SuC 222-3 for supplementary cell services.

Process 1200 can include UE 210 detecting an RLF corresponding to PCell 222-1 (block 1240). For example, UE 210 can monitor a strength, quality, reliability, latency, and/or one or more other types of link-related characteristics with respect to PCell 222-1. UE 210 can compare the monitored or measured characteristics with one or more link-related thresholds and determine that a radio link between UE 210 and PCell 222-1 has failed when the measured characteristic(s) breach the designated threshold(s).

Process 1200 can include UE 210 generating PCell failure information (block 1250). For example, in response to detecting a RLF between UE 210 and PCell 222-1, UE 210 can produce information related to the radio link, the failure of the radio link, PCell 222-1, UE 210, and more. PCell failure information can include one or more types and/or combinations of a variety of information that can be used to enable fast PCell recovery as described herein. PCell failure information can include signal measurements relating to one or more other cells (e.g., neighboring cells) in the area. PCell failure information can also be referred to a RLF information.

Referring to Option 1.1 of FIG. 12, when a configured grant is provided, process 1200 can include UE 210 using the SUL resources of the configured grant to send the PCell failure information to SuC 222-3 (block 1260). Referring to Option 1.2 of FIG. 12, when a configured grant is not provided, UE 210 can perform a random access procedure directed at SuC 222-3 and send the PCell failure information to SuC 222-3 using UL resources resulting from the random access procedure. For example, in accordance with the configuration information received from PCell 222-1, UE 210 can send a RACH preamble message (msg 1) to SuC 222-3 (block 1270). In some implementations, UE 210 can also, or alternatively, determine the RACH configuration for SuC 222-3 based on system information blocks (SIBs) from SuC 222-3. SuC 222-3 can respond to UE 210 by sending a random access response message (e.g., a RACH message 2 (msg 2)) (block 1280). And UE 210 can send SuC 222-3 a RACH message 3 (msg 3) that includes PCell failure information (block 1290). The PCell failure information can include signal strength measurements of neighboring cells (e.g., target SpCell) and/or a signal strength measurement of SuC 222-3.

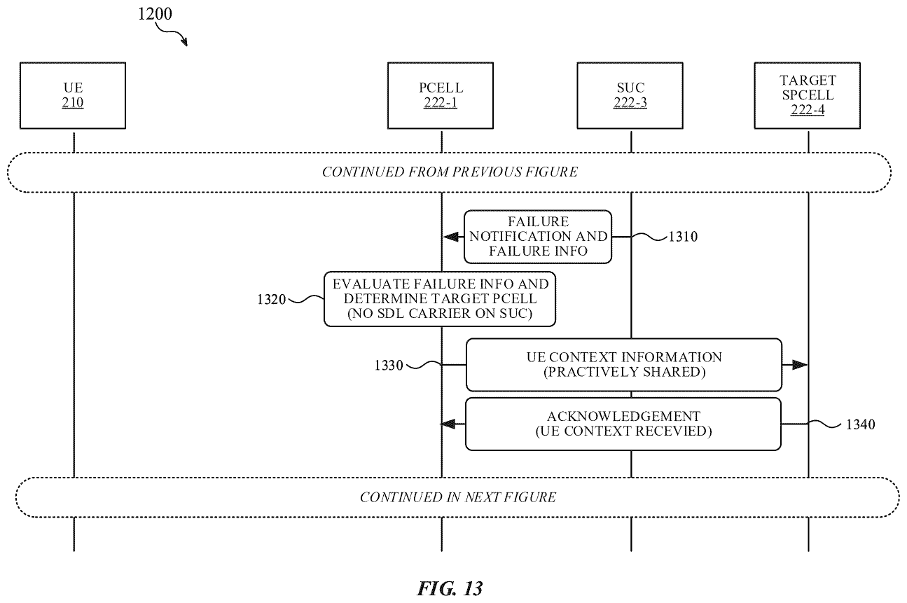

Referring to FIG. 13, process 1200 can include SuC 222-3 communicating a failure notification and the PCell failure information to PCell 222-1 (block 1310). For example, SuC 222-3 can receive the PCell failure information from UE 210. In response, SuC 222-3 can generate a failure message or notification relating to the RLF between UE 210 and PCell 222-1. SuC 222-3 can also communicate the failure message and the PCell failure information to PCell 222-1. In some implementations, the PCell failure information can be or function as the failure message or notification.

Process 1200 can also include PCell 222-1 determinizing a target PCell based on the PCell failure information (block 1320). For example, PCell 222-1 can receive the failure notification and PCell failure information from SuC 222-3. As described above, the PCell failure information can include an indication of an RLF and signal quality and/or signal strength measurements and identification information corresponding to one or more cells (e.g., neighboring cells), including SuC 222-3 and target SpCell 222-4. PCell 222-1 can evaluate the PCell failure information to determine a target cell to become a the PCell for UE 210. For purposes of explaining process 1200, assume that SuC 222-3 was configured with an SUL carrier but not an SDL carrier. As such, an SDL carrier may not be used for fast PCell recovery (see, e.g., block 820 of FIG. 8, block 1040 of FIG. 10, block 1120 of FIG. 11, etc.). In such a scenario, PCell 222-1 can determine a target cell for being the new PCell based on the PCell failure information. For purposes of explaining process 1200, assume that PCell 222-1 determines that target SpCell 222-4 is to be the new PCell for UE 210.

Process 1200 can also include PCell 222-1 determining UE context information associated with UE 210, and the failed link between UE 210 and PCell 222-1. PCell 222 can communicate the UE context information to SpCell 222-4 (block 1330). UE context information can include various parameters and settings that define the connectivity and behavior of UE 210 within the network. While not shown, in some implementations PCell 222-1 can identify multiple target cell that can operate as the new PCell for UE 210 and can proactively send UE context information to each of the target cells. Providing the UE context information can enable UE 210 to initiate and complete an RRC reestablishment procedure with one of the target cells. As shown, target cells (such as SpCell 222) that receive the UE context information can response to PCell 222 with an acknowledgement message (block 1340). A target cell having the UE context information can facilitate and expedite the RRC reestablishment procedure and thus enable fast PCell recovery. While not shown, in response to a target cell acknowledging receiving of the UE context information, PCell 222 can communicate to other target cell that the UE context information can be deleted or disregarded.

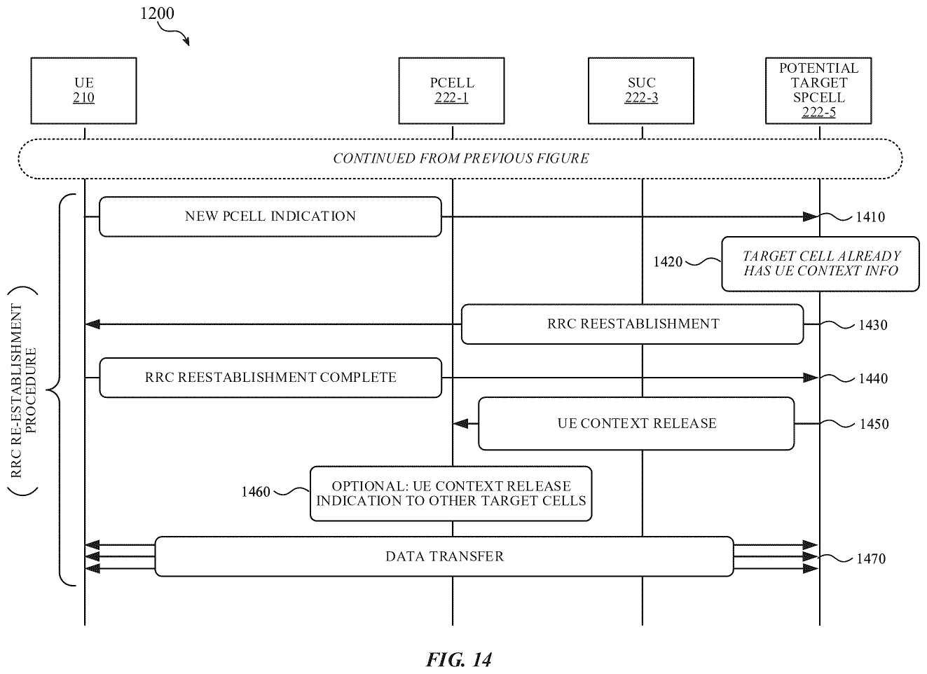

Referring to the RRC reestablishment procedure of FIG. 14, process 1200 can include UE 210 sending target SpCell 222-4 an RRC reestablishment request (block 1410). As described above, target SpCell 222-4 can already have received UE context information for the RRC reestablishment procedure from PCell 222 (block 1420). As such, target SpCell 222-4 can forego typical RRC reestablishment procedure operation, such as sending a request to PCell 222 for UE context information and waiting for PCell 222 to provide the UE context information.

Process 1200 can include target SpCell 222-4 can continue the reestablishment of the RRC connection by sending an RRC reestablishment message to UE 210 via a system resource block (e.g., SRB1) (block 1430). In some implementations, target SpCell 222-4 can also, or alternatively, perform the reconfiguration to re-establish SRB2 and data resource blocks (DRBs) when the re-establishment procedure is ongoing. In response to the RRC reestablishment message, UE 210 can reestablish a connection with that network with target SpCell 222-4 functioning as the new PCell for UE 210. UE 210 can send target SpCell 222-4 an RRC reestablishment complete message (block 1440). In response, target SpCell 222-4 can send PCell 222 a UE context release message (block 1450) can PCell 222 can respond in kind. In some implementations, PCell 222 can send a UE context release message to one or more other target cells (e.g., other than target SpCell 222) (block 1460). As a result, target SpCell 222-4 can operate as the new PCell for UE 210, such that network connectivity is restored and UE 210 and target SpCell 222-4 can engage in one or more types of data transfers going forward (block 1470). As such, process 1200 can include UE 210 and target SpCell 222-4 preforming fast cell recovery using an RRC reestablishment initiated by PCell 222-1.

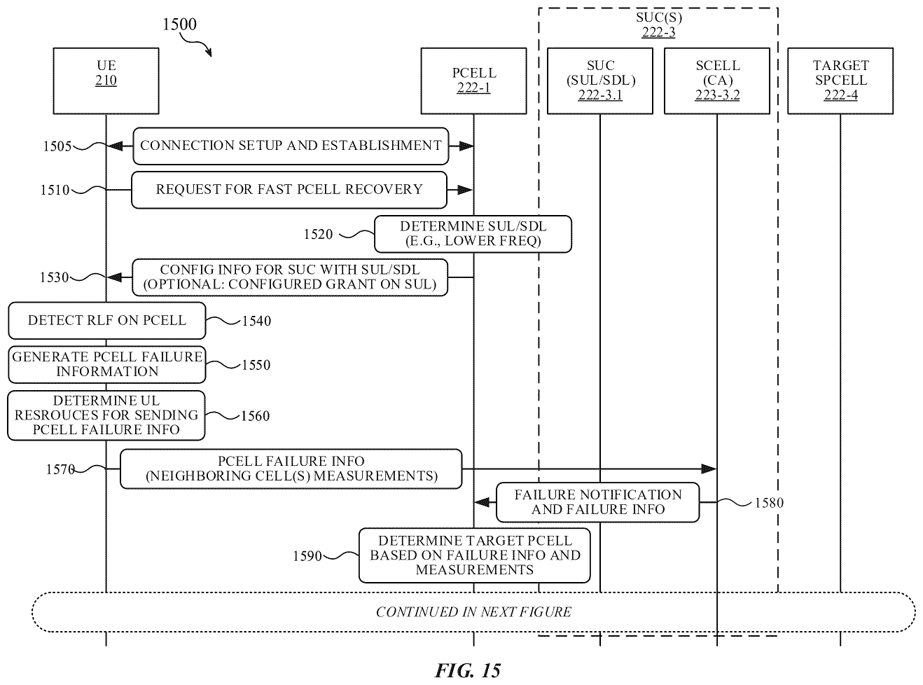

FIGS. 15-17 are diagrams of an example process 1500 for fast PCell recovery via SuC with CA and SUL and SDL carriers according to one or more implementations described herein. Process 1500 can be implemented by UE 210, PCell 222-1, SuC 222-3, and target SpCell 222-4. PCell 222-1, SuC 222-3, and/or target SpCell 222-4 can be implemented by one or more base station 222, which can or may not involve an MCG 310 and/or SCG 320. SUC 222-3 can represent an SuC 222-3.1 with SUL and SDL resources and SCell 222-3.2 using CA. For purpose of explaining example process 1500, assume that SuC 222-3.1 and SCell 222-3.2 are capable of providing support services to UE 210 (see, e.g., the example of FIG. 6 described above).

In some implementations, some or all of process 1500 can be performed by one or more other systems or devices, including one or more of the systems or devices of FIGS. 2-6. Additionally, process 1500 can include one or more fewer, additional, differently ordered and/or arranged operations than those shown in FIGS. 15-17. Some or all of the operations of process 1500 can be performed independently, successively, simultaneously, etc., of one or more of the other operations of process 1500. Further, one or more of the operations of process 1500 can include one or more of the features, conditions, information, characteristics, etc., described elsewhere herein. As such, the techniques described herein are not limited to the number, sequence, arrangement, timing, type, etc., of the operations or processes depicted in FIGS. 15-17.

As shown, process 1500 can include UE 210 communicating with PCell 222-1 to setup and establish a connection or radio link that enables UE 210 and PCell 222-1 to communicate with one another (block 1505). This can include one or more types of RACH procedures, allocations of time and frequency resources, one or more types of messages, and the use of one or more types of UL and/or DL channels. As shown, process 1500 can include UE 210 communicating a request to PCell 222-1 for fast PCell recovery (block 1510).

Process 1500 can also include PCell 222-1 communicating SuC configuring information to SuC 222-3 (block 1508). For example, PCell 222-1 can determine and communicate UL and DL resources to enable SuC 222-3 to provide supplementary connectivity services to UE 210. The resource can include SUL and SDL resources when SuC 222-3 operates as an SuC. When operating as a SCell, the UL and DL resources can be implemented via CA.

Process 1500 can include PCell 222-1 determining supplementary resources for fast PCell recovery (block 1520). The supplementary resources can be SUL and SDL resources, or UL and DL resources can be implemented via CA. The supplementary resources can use lower frequencies for UL and DL signaling than frequencies used by PCell 222-1 for UL and DL signaling. This may, for example, increase a coverage area for supplementary communications, help prevent path loss, reduce the risk of signal interference, and more. In some implementations, the use of lower frequencies can be limited to supplementary resources for UL signaling.

Process 1500 can also include PCell 222-1 communicating configuration information for supplementary cell services via SUL and/or SDL resources (block 1530). In some implementations, the configuration information can include a configured grant for communicating with SuC 222-3. In some implementations, the configuration information does not include a configured grant but can include other information to enable fast PCell recovery as described herein, such as information indicating or identifying SuC 222-3 for supplementary cell services.

Process 1500 can include UE 210 detecting an RLF corresponding to PCell 222-1 (block 1540). For example, UE 210 can monitor a strength, quality, reliability, latency, and/or one or more other types of link-related characteristics with respect to PCell 222-1. UE 210 can compare the monitored or measured characteristics with one or more link-related thresholds and determine that a radio link between UE 210 and PCell 222-1 has failed when the measured characteristic(s) breach the designated threshold(s).

Process 1500 can include UE 210 generating PCell failure information (block 1550). For example, in response to detecting a RLF between UE 210 and PCell 222-1, UE 210 can produce information related to the radio link, the failure of the radio link, PCell 222-1, UE 210, and more. PCell failure information can include one or more types and/or combinations of a variety of information that can be used to enable fast PCell recovery as described herein. PCell failure information can include signal measurements relating to one or more other cells (e.g., neighboring cells) in the area, such as signal measurements regarding the SUL and SDL of SuC 222-3.1, the CA resources of SCell 222-3.2, and/or signal measurements of target SpCell 222-4. PCell failure information can also be referred to a RLF information.

Process 1500 can include UE 210 determining whether to use the SUL of SuC 222-3.1 or CA resources of SCell 222-3.2 to communicate the PCell failure information to PCell 222-1. For example, UE 210 can measure a signal strength and determine a signal quality relative to SuC 222-3.1 and SCell 222-3.2. UE 210 can determine whether to use supplementary services of SuC 222-3.1 or supplementary services SCell 222-3.2 for fast cell recovery purposes. For example, UE 210 can compare the measured signals to one another, apply one or more thresholds to the measured signals, and/or apply one or more rules configured to help evaluate the measured signals and/or select an appropriate supplementary service.

UE 210 can apply a signal quality threshold to one or more of the measured signals. The threshold applied to SUL and/or SDL resources can be the same or different, in terms of threshold level, parameter type, etc., then the threshold applied to CA resources. An example of a rule applied to the measured signals can include a preference of one type of resource (e.g., SUL/DUL) over another type of resource (e.g., CA) when the measured quality is the same or within a threshold delta. Characteristics of the measured signal can include one or more, or any combination of parameters, such as a signal strength, a latency, a jitter, a signal-to-noise ratio, an amount of network congestion, a loss rate, etc. For purposes of explaining process 1500, assume that UE 210 determines that SCell 222-3.2 is more appropriate for fast cell recovery purpose than SuC 222-3.1.

Process 1500 can also include UE 210 communicating the PCell failure information to SCell 222-3.2 (block 1570). For example, UE 210 can determine that a signal strength between UE 210 and SCell 222-3.2 is viable despite the RLF of PCell 222-1. As such, instead of initiating an RRC reestablishment procedure, UE 210 can send PCell failure information to SCell 222-3.2. UE 210 can the send PCell failure information using the lower frequencies of the CA resources of SCell 222-3.2, as opposed to the higher frequencies allocated for signaling PCell 222-1.

Process 1500 can include SCell 222-3.2 communicating a failure notification and the PCell failure information to PCell 222-1 (block 1580). For example, SCell 222-3.2 can receive the PCell failure information from UE 210. In response, SCell 222-3.2 can generate a failure message or notification relating to the RLF between UE 210 and PCell 222-1. SCell 222-3.2 can also communicate the failure message and the PCell failure information to PCell 222-1. In some implementations, the PCell failure information can function as the failure message or notification.

Process 1500 can also include PCell 222-1 determining a target PCell based on the PCell failure information (block 1590). For example, PCell 222-1 can receive the failure notification and PCell failure information from SCell 222-3.2. As described, the PCell failure information can include signal strength measurements and identification information corresponding to one or more cells in the area (e.g., SuC 222-3.1, SCell 222-3.2, target SpCell 222-4, and other neighboring cells). PCell 222-1 can evaluate the PCell failure information to determine a target cell for becoming a new PCell for UE 210. For example, when a link quality of SuC 222-3 is greater than a link quality threshold, and/or when the link quality of SuC 222-3 is greater than a link quality of target SpCell 222, PCell 222-1 can communicate with SuC 222-3 to cause or configure SuC 222-3 to operate as the new PCell for UE 210. This can include establishing SRBs to enable SuC 222-3 to communicate with UE 210, configuring SuC 222-3 for RLM regarding links between SuC 222-3 and UE 210, and more.

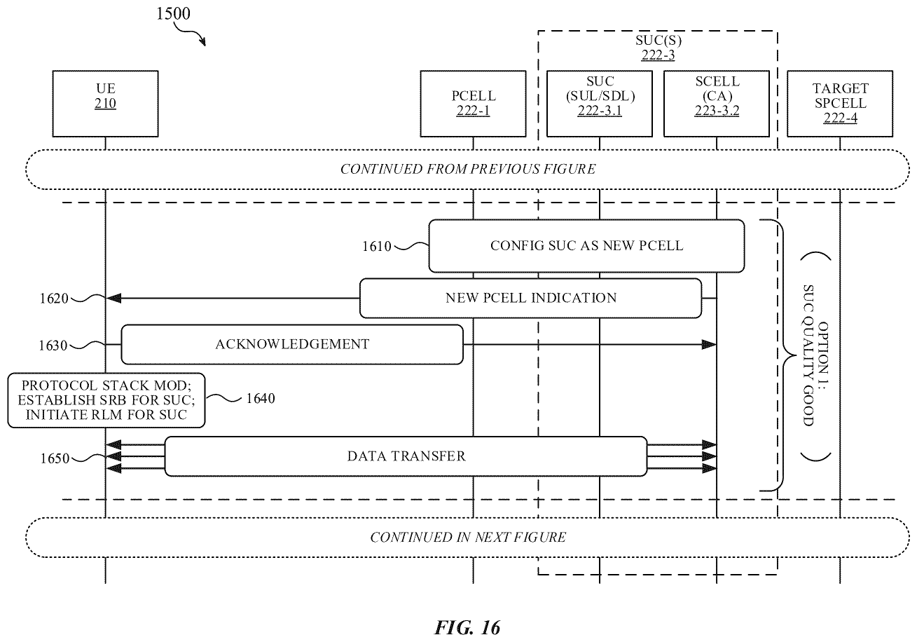

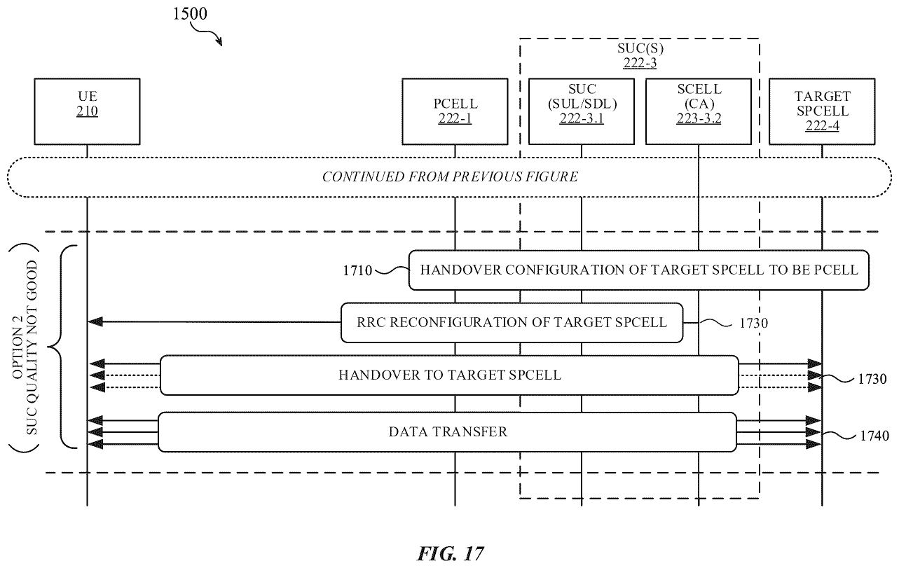

Referring to Option 1.2 of FIG. 16, process 1500 can include PCell 222-1 configuring SuC 222-3.1 or SCell 222-3.2 to be the new PCell for UE 210 (block 1610). This can include establishing SRBs to enable SuC 222-3 to communicate with UE 210, configuring SuC 222-3 for RLM regarding links between SuC 222-3 and UE 210, and more. For purposes of explain FIGS. 16-17, certain operations are described as being performed by SCell 222-3.2. Such operations can also, or alternatively, be performed by SuC 222-3.1 in another scenario or implementation. Similarly, operations described as being performed by SCell 222-3.2 can be performed by SuC 222-3.1 in another scenario or implementation. In some implementations, an operation described as being performed by either SuC 222-3.1 or SCell 222-3.2, can be performed by a combination of SuC 222-3.1 and SCell 222-3.2. As such, the operations or functionality of either SuC 222-3.1 or SCell 222-3.2 can be generally described as being performed by SuC 222-3.

Process 1500 can also include SuC 222-3 sending UE 210 an indication that SuC 222-3 is to operate as the new PCell for UE 210 (block 1630). The indication can include configuration information for SRBs, RLM, and more. In implementations where UE 210 uses an SUL to communicate PCell failure information, but SuC 222-3.1 is not configured with a DUL, DL communications can use DL CA resources of SCell 222-3.2. Thus, communications between SuC 222-3 and UE 210 can use any combination of SUL, DUL, or CA resources of SuC 222-3.1 and SCell 222-3.2.

Process 1500 can also include UE 210 receiving the indication and respond to SuC 222-3 with an acknowledgement message (block 1650). Process 1500 can include UE 210 updating a protocol stack or creating a new protocol stack for communicating with SuC 222-3 as the new PCell (block 1640). UE 210 can also establish one or more SRBs and implement RLC with respect to SuC 222-3 as the new PCell. Process 1500 can also include SuC 222-3 operating as the new PCell for UE 210, such that network connectivity is recovered and UE 210, and SuC 222-3 and UE 210 engaging in data transfers going forward (block 1650).

Referring to FIG. 17, as mentioned above, PCell 222-1 can determine that target SpCell 222-4 is to be the new PCell based on a measured signal quality or signal strength between UE 210 and SuC 222-3, UE 210 and target SpCell 222-4, or a combination thereof (Option 2.2). For example, when a link quality of SuC 222-3 is less than a link quality threshold, when a link quality of SpCell 222-4 is greater than a link quality threshold, and/or when the link quality of SpCell 222-4 is greater than a link quality of SuC 222-3, PCell 222-1 can configure of SuC 222-3 and/or SpCell 222-4 for a handover procedure between UE 210 and SpCell 222-4 (block 1710). PCell 222 can provide SuC 222-3 and/or SpCell 222-4 with configuration information that identifies SpCell 222-4 and/or UE 210 for a handover procedure.

Process 1500 can also include SuC 222-3 generating RRC reconfiguration information for the handover procedure toward SpCell 222-4 and can communicating the RRC reconfiguration information to UE 210 (block 1720). For example, SuC 222-3 can send UE 210 an RRC reconfiguration information that identifies target SpCell 222-4, identifies resources for communicating with target SpCell 222-4, and/or prompts UE 210 to initiate a handover procedure from toward target SpCell 222-4. As such, process 1500 can include UE 210 and target SpCell 222-4 communicating to perform a handover procedure (block 1730). As a result, target SpCell 222-4 can operate as the new PCell for UE 210, such that network connectivity is restored and UE 210 and target SpCell 222-4 can engage in one or more types of data transfers going forward (block 1740).

Accordingly, one or more of the techniques described herein can include scenarios in which PCell 222-1 can configure SUL/SDL carriers and an SCell with CA. SuC 222-3 can share link failure information with PCell 222-1 to enable fast PCell recovery. When SuC link quality is good, the PCell 222-1 can configure SuC 222-3 to become new PCell for UE 210 and can indicate this information to UE 210 via DL resources of the SuC 222-3. When the neighboring cell measurements are good (e.g., target SpCell 222-4), PCell 222-1 can configure target SpCell 222-4 to handover UE 210 from PCell 222-1 to target SpCell 222-4. The RRC reconfiguration of target SpCell 222-4 can be transmitted via the SDL resources of SuC 222-3.1 or DL CA resources of SCell 222-3.2.

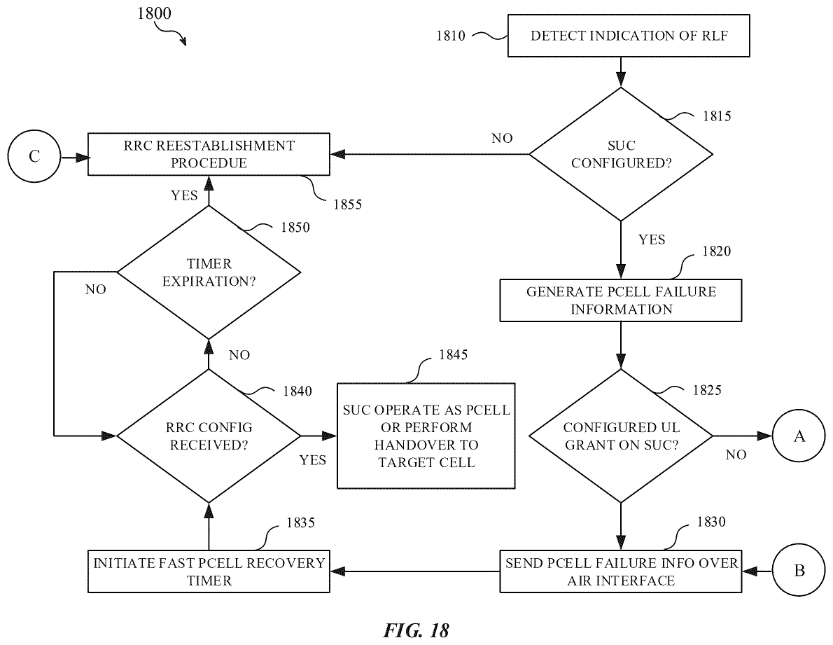

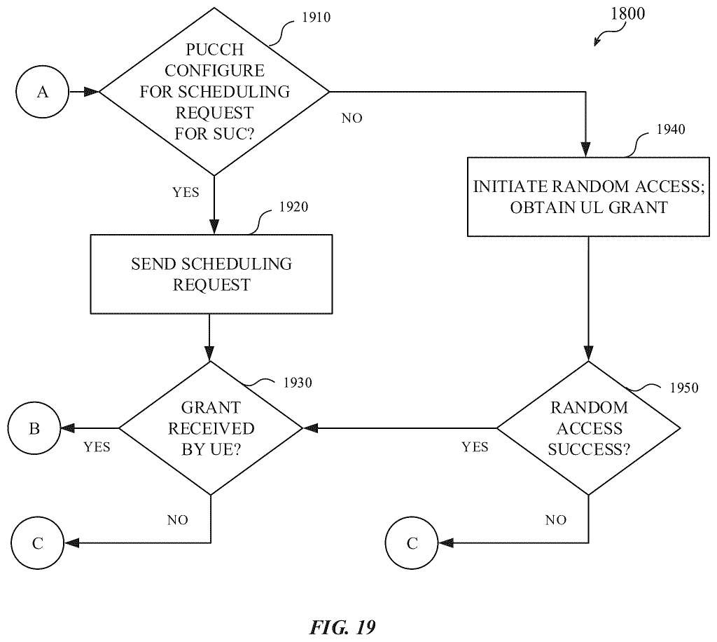

FIGS. 18-19 are diagrams of an example UE process 1800 for fast PCell recovery according to one or more implementations described herein. Process 1800 can be implemented by UE 210. One or more of the operations of process 1800 can occur at, or pertain to, a protocol stack layer, such as a physical (PHY) layer, medium access control (MAC) layer, radio link control (RLC) layer, RRC layer, etc. In some implementations, some or all of process 1800 can be performed by one or more other systems or devices, including one or more of the systems or devices of FIGS. 2-6. Additionally, process 1800 can include one or more fewer, additional, differently ordered and/or arranged operations than those shown in FIGS. 18-19. Some or all of the operations of process 1800 can be performed independently, successively, simultaneously, etc., of one or more of the other operations of process 1800. Further, one or more of the operations of process 1800 can include one or more of the features, conditions, information, characteristics, etc., described elsewhere herein. As such, the techniques described herein are not limited to the number, sequence, arrangement, timing, type, etc., of the operations or processes depicted in FIGS. 18-19.

As shown, process 1800 can include detecting a radio link failure (RLF) (block 1810). For example, UE 210 can establish a connection with PCell 222-1, monitor the connection, and detect when the connection fails. UE 210 can do so in one or more ways, which can include monitoring, measuring, and evaluating one or more characteristics of the radio link with PCell 222-1, such as a signal strength, quality, reliability, packet loss, etc. UE 210 can detect the RFL at an RRC layer of UE 210.

As shown, process 1800 can include determining whether a supplementary cell is configured (block 1815). For example, UE 210 can determine whether a cell is configured to provide supplementary connection services has been configured for UE 210. UE 210 can determine whether a SuC is configured at an RRC layer of UE 210. In some implementations, even when UE 210 is configured with SuC configuration, an RRC layer of UE 210 can be agnostic to an activation status of the SuC when the activation is performed by lower layers. In such scenarios, the RRC layer of UE 210 can request the activation status of SuC from the lower layers. Alternatively, detection of the RLF indication can include the RRC layer receiving, from the lower layers, a notification of the RLF and the activation status of SuC.

The cell can be configured as an SuC with SUL and/or SDL resources, or a SCell with CA resources configured for providing supplementary connection services. In some implementations, UE 210 can determine whether one or more cells have been configured to provide supplementary services to UE 210. UE 210 can initiate an RRC reestablishment procedure with the network in response to detecting a RLF with PCell 222 and there being no supplementary connection services available to UE 210 (block 1855).

As shown, process 1800 can include generating PCell failure information (block 1820). For example, UE 210 can produce PCell failure information in response to detecting a RLF from PCell 222 and supplementary connection services being available to UE 210. The PCell failure information can be referred to a RLF information. PCell failure information can include one or more of a variety of types of information, such as an indication of a RLF with PCell 222 and signal strength or quality measurements of one or more neighboring cells, such as SuC 222-3, target SpCell, etc. In some implementations, the PCell failure information can include measurement information obtained in response to the RLF event or the most recent measurement information obtained by UE 210.

Process 1800 can also include determining whether there is a UL grant from the SuC (block 1825). For example, UE 210 can determine whether a resource grant has been received for sending UL data to the network via SuC 222-3. When a UL grant has been received, UE 210 can send the PCell failure information to SuC 222-3 via an air interface (e.g., using the time and frequency recourses of the UL grant) (block 1830). The UL grant can correspond to a PUSCH. UE 210 can configure a MAC layer to allow or enable transmission of failure information over the SuC carrier. By contrast, UE 210 can respond to not having received a UL grant as described below with block 1910 of FIG. 19 (at A).

Process 1800 can also include initiating a fast cell recovery timer (block 1835). For example, UE 210 can start a timer that comprises an amount of time permitted for restoring the radio link via fast PCell recovery. The time can be a FastPCellRecoveryTimer parameter. AS such, when UE 210 fails to receive an RRC configuration (e.g., an RRC reconfiguration) from the network (block 1840) within the duration of the fast cell recovery timer (block 1850), process 1800 can include UE 210 initiating an RRC reestablishment procedure with the network (block 1855). When UE 210 receives an RRC configuration from the network before the fast cell recovery timer expires (block 1850), process 1800 can include UE 210 completing the fast PCell recovery by as SuC 222-3 begins operating as the new PCell or a handover procedure is performed toward a target cell configured to be the new PCell (block 1845).

Referring to FIG. 19, process 1800 can include UE 210 determining whether a physical UL control channel (PUCCH) is configured for a scheduling request for SuC communications (block 1910). For example, UE 210 can determine whether a PUCCH has been configured for UE 210 to make scheduling requests for SUL communications. The PUCCH configuration of SuC can include an IE (e.g., PUCCHSuCPattern) that is configured by SuC 222-3 so that SuC 222-3 can know when to listen for transmissions from UE 210.

Process 1800 can also include UE 210 sending a scheduling request to SuC 222-3 when the PUCCH has been configured (block 1920). When a grant is received (block 1930-B), process 1800 can include UE 210 sending PCell information to SuC 222-3 via an air interface (block 1830 of FIG. 18). When a grant is received (block 1930-C), process 1800 can include UE 210 initiating an RRC reestablishment procedure with the network (block 1855 of FIG. 18).

Process 1800 can also include UE 210 initiating a random access procedure toward SuC 222-3 when the PUCCH has not been configured (block 1940). When the random access procedure is successful (block 1950—Yes), process 1800 can include determining whether a scheduling grant for communicating with SuC 222-3 is received (block 1930). When the random access procedure is not successful (block 1950—C), process 1800 can include UE 210 initiating an RRC reestablishment procedure with the network (block 1855 of FIG. 18).

One or more of the processes and operations can be include one or more additional or alternative features, parameters, or other types of modifications. In some implementations, UE 210 can indicate a PCell failure to SuC 222-3 using the PUCCH of SuC 222-3. The indication can include a 1-bit flab (a 1 or 0). The network (e.g., PCell 222-1) can use previously reported measurements to determine a new PCell target and trigger a handover procedure toward the new PCell. An RRC reconfiguration can be sent to UE 210 by SuC 222-3. In some implementations, the indication over the PUCCH can also, or alternatively, include a set of potential PCells for a handover procedure. When the measurements at the network are old (e.g., last measurement is from 10 mins ago), the network can send a UL grant from SuC 222-3 to request from UE 210 a transmission of latest measurements of SuC 222-3, target PSCell, and/or other neighboring cells. In some implementations, the scheduling request sent to SuC 222-3 via the PUCCH can, in response, receive a grant for transmission of PCell failure information that includes a flag to indicate to the network to prioritize scheduling. In some implementations, UE 210 can increase a periodicity of communication with SuC 222-3 and the neighboring cell measurements when a timer (e.g., a T310 timer) is initiated due to a link failure with PCell 222-1.

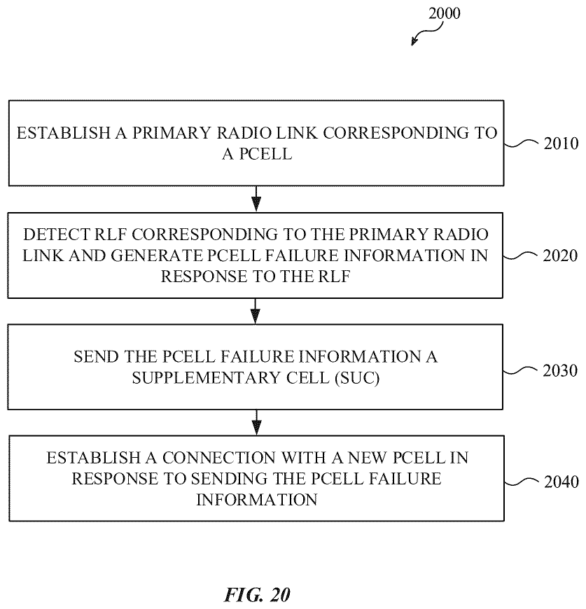

FIG. 20 is a diagram of an example process 2000 for fast PCell recovery according to one or more implementations described herein. Process 2000 can be implemented by UE 210. In some implementations, some or all of process 2000 can be performed by one or more other systems or devices, including one or more of the systems or devices of FIGS. 2-6. Additionally, process 2000 can include one or more fewer, additional, differently ordered and/or arranged operations than those shown in FIG. 20. Some or all of the operations of process 2000 can be performed independently, successively, simultaneously, etc., of one or more of the other operations of process 2000. Further, one or more of the operations of process 2000 can include one or more of the features, conditions, information, characteristics, etc., described elsewhere herein. As such, the techniques described herein are not limited to the number, sequence, arrangement, timing, type, etc., of the operations or processes depicted in FIG. 20.

As shown, process 2000 can include establishing a primary radio link corresponding to a PCell (block 2010). Process 2000 can also include detecting a radio link failure (RLF) corresponding to the primary radio link and generating PCell failure information in response to the RLF (block 2020). Process 2000 can include sending the PCell failure information a supplementary cell (SuC) (block 2030). Process 2000 can also include establishing a connection with a new PCell in response to sending the PCell failure information (block 2040).

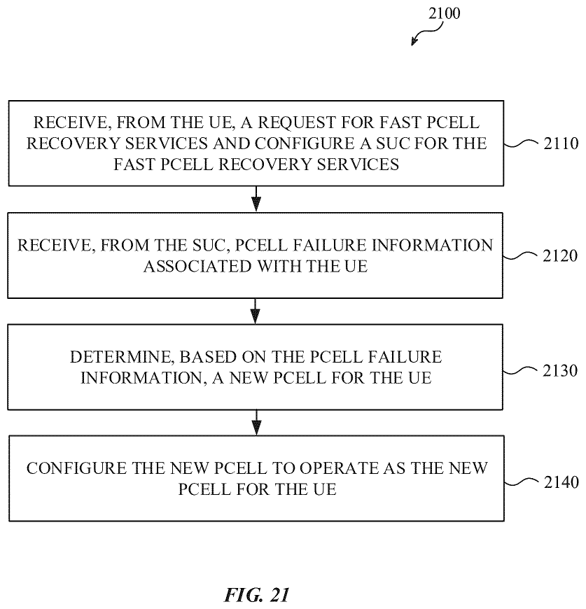

FIG. 21 is a diagram of an example of another process 2100 for fast PCell recovery according to one or more implementations described herein. Process 2100 can be implemented by base station 222 operating as a PCell. In some implementations, some or all of process 2100 can be performed by one or more other systems or devices, including one or more of the systems or devices of FIGS. 2-6. Additionally, process 2100 can include one or more fewer, additional, differently ordered and/or arranged operations than those shown in FIG. 21. Some or all of the operations of process 2100 can be performed independently, successively, simultaneously, etc., of one or more of the other operations of process 2100. Further, one or more of the operations of process 2100 can include one or more of the features, conditions, information, characteristics, etc., described elsewhere herein. As such, the techniques described herein are not limited to the number, sequence, arrangement, timing, type, etc., of the operations or processes depicted in FIG. 21.

As shown, process 2100 can include receiving, from the UE, a request for fast PCell recovery services and configuring a SuC for the fast PCell recovery services (block 2110). Process 2100 can also include receiving, from the SuC, PCell failure information associated with the UE (block 2120). Process 2100 can include determining, based on the PCell failure information, a new PCell for the UE (block 2130). Process 2100 can also include configuring the new PCell to operate as the new PCell for the UE (block 2140).

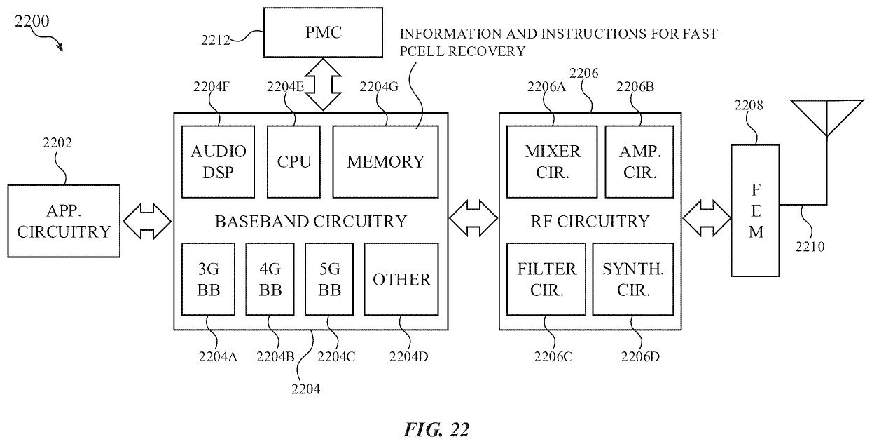

FIG. 22 is a diagram of an example of components of a device according to one or more implementations described herein. In some implementations, the device 2200 can include application circuitry 2202, baseband circuitry 2204, RF circuitry 2206, front-end module (FEM) circuitry 2208, one or more antennas 2210, and power management circuitry (PMC) 2212 coupled together at least as shown. The components of the illustrated device 2200 can be included in a UE or a RAN node. In some implementations, the device 2200 can include fewer elements (e.g., a RAN node may not utilize application circuitry 2202, and instead include a processor/controller to process IP data received from a CN or an Evolved Packet Core (EPC)). In some implementations, the device 2200 can include additional elements such as, for example, memory/storage, display, camera, sensor (including one or more temperature sensors, such as a single temperature sensor, a plurality of temperature sensors at different locations in device 2200, etc.), or input/output (I/O) interface. In other implementations, the components described below can be included in more than one device (e.g., said circuitries can be separately included in more than one device for Cloud-RAN (C-RAN) implementations).

The application circuitry 2202 can include one or more application processors. For example, the application circuitry 2202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 2200. In some implementations, processors of application circuitry 2202 can process IP data packets received from an EPC.

The baseband circuitry 2204 can include circuitry such as, but not limited to, one or more single-core or multi-core processors. The baseband circuitry 2204 can include one or more baseband processors or control logic to process baseband signals received from a receive signal path of the RF circuitry 2206 and to generate baseband signals for a transmit signal path of the RF circuitry 2206. Baseband circuity 2204 can interface with the application circuitry 2202 for generation and processing of the baseband signals and for controlling operations of the RF circuitry 2206. For example, in some implementations, the baseband circuitry 2204 can include a 3G baseband processor 2204A, a 4G baseband processor 2204B, a 5G baseband processor 2204C, or other baseband processor(s) 2204D for other existing generations, generations in development or to be developed in the future (e.g., 5G, 6G, etc.). The baseband circuitry 2204 (e.g., one or more of baseband processors 2204A-D) can handle various radio control functions that enable communication with one or more radio networks via the RF circuitry 2206. In other implementations, some or all of the functionality of baseband processors 2204A-D can be included in modules stored in the memory 2204G and executed via a Central Processing Unit (CPU) 2204E. The radio control functions can include, but are not limited to, signal modulation/demodulation, encoding/decoding, radio frequency shifting, etc. In some implementations, modulation/demodulation circuitry of the baseband circuitry 2204 can include Fast-Fourier Transform (FFT), precoding, or constellation mapping/de-mapping functionality. In some implementations, encoding/decoding circuitry of the baseband circuitry 2204 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 2204G can receive, store, and/or provide information and instructions for enabling fast PCell recovery using an SuC 222-3 to configure the new PCell and restore a failed radio link between a UE 210 and a previous PCell 222-1. UE 210 can have a first radio link with a PCell 222-1 and a second radio link with a SuC 222-3. UE 210 can detect an RLF corresponding to the PCell 222-2, and in response to the failure, can use the SuC 222-3 to recover connectivity. That is, UE 210 can send PCell failure information to the SuC 222-3 and, in response to the PCell failure information, the network can configure another cell to operate as a new PCell for the UE. Depending on the scenario, the new PCell can be an SpCell configured with PCell configuration information, the SuC 222-3 configured with PCell configuration information, or another type of cell (e.g., SpCell 222-4). The new PCell and UE 210 can then communicate with one another to establish a new radio link to replace the failed radio link. These and many other features and examples are described herein.

In some implementations, the baseband circuitry 2204 can include one or more audio digital signal processor(s) (DSP) 2204F. The audio DSPs 2204F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 2204 and the application circuitry 2202 can be implemented together such as, for example, on a system on a chip (SOC).

In some implementations, the baseband circuitry 2204 can provide for communication compatible with one or more radio technologies. For example, in some implementations, the baseband circuitry 2204 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 2204 is configured to support radio communications of more than one wireless protocol can be referred to as multi-mode baseband circuitry.

RF circuitry 2206 can enable communication with wireless networks using modulated electromagnetic radiation through a non-solid medium. In various implementations, the RF circuitry 2206 can include switches, filters, amplifiers, etc. to facilitate the communication with the wireless network. RF circuitry 2206 can include a receive signal path which can include circuitry to down-convert RF signals received from the FEM circuitry 2208 and provide baseband signals to the baseband circuitry 2204. RF circuitry 2206 can also include a transmit signal path which can include circuitry to up-convert baseband signals provided by the baseband circuitry 2204 and provide RF output signals to the FEM circuitry 2208 for transmission.

In some implementations, the receive signal path of the RF circuitry 2206 can include mixer circuitry 2206A, amplifier circuitry 2206B and filter circuitry 2206C. In some implementations, the transmit signal path of the RF circuitry 2206 can include filter circuitry 2206C and mixer circuitry 2206A. RF circuitry 2206 can also include synthesizer circuitry 2206D for synthesizing a frequency for use by the mixer circuitry 2206A of the receive signal path and the transmit signal path. In some implementations, the mixer circuitry 2206A of the receive signal path can be configured to down-convert RF signals received from the FEM circuitry 2208 based on the synthesized frequency provided by synthesizer circuitry 2206D. The amplifier circuitry 2206B can be configured to amplify the down-converted signals and the filter circuitry 2206C can be a low-pass filter (LPF) or band-pass filter (BPF) configured to remove unwanted signals from the down-converted signals to generate output baseband signals. Output baseband signals can be provided to the baseband circuitry 2204 for further processing. In some implementations, the output baseband signals can be zero-frequency baseband signals, although this is not a requirement. In some implementations, mixer circuitry 2206A of the receive signal path can comprise passive mixers, although the scope of the implementations is not limited in this respect.

In some implementations, the mixer circuitry 2206A of the transmit signal path can be configured to up-convert input baseband signals based on the synthesized frequency provided by the synthesizer circuitry 2206D to generate RF output signals for the FEM circuitry 2208. The baseband signals can be provided by the baseband circuitry 2204 and can be filtered by filter circuitry 2206C.

In some implementations, the mixer circuitry 2206A of the receive signal path and the mixer circuitry 2206A of the transmit signal path can include two or more mixers and can be arranged for quadrature down conversion and up conversion, respectively. In some implementations, the mixer circuitry 2206A of the receive signal path and the mixer circuitry 2206A of the transmit signal path can include two or more mixers and can be arranged for image rejection (e.g., Hartley image rejection). In some implementations, the mixer circuitry 2206A of the receive signal path and the mixer circuitry 1406A can be arranged for direct down conversion and direct up conversion, respectively. In some implementations, the mixer circuitry 2206A of the receive signal path and the mixer circuitry 2206A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 2206 can include analog-to-digital converter (ADC) and digital-to-analog converter (DAC) circuitry and the baseband circuitry 2204 can include a digital baseband interface to communicate with the RF circuitry 2206.

In some dual-mode implementations, a separate radio IC circuitry can be provided for processing signals for each spectrum, although the scope of the implementations is not limited in this respect.

In some implementations, the synthesizer circuitry 2206D can be a fractional-N synthesizer or a fractional N/N+1 synthesizer, although the scope of the implementations is not limited in this respect as other types of frequency synthesizers can be suitable. For example, synthesizer circuitry 2206D can be a delta-sigma synthesizer, a frequency multiplier, or a synthesizer comprising a phase-locked loop with a frequency divider.

The synthesizer circuitry 2206D can be configured to synthesize an output frequency for use by the mixer circuitry 2206A of the RF circuitry 2206 based on a frequency input and a divider control input. In some implementations, the synthesizer circuitry 2206D can be a fractional N/N+1 synthesizer.

In some implementations, frequency input can be provided by a voltage-controlled oscillator (VCO), although that is not a requirement. Divider control input can be provided by either the baseband circuitry 2204 or the applications circuitry 2202 depending on the desired output frequency. In some implementations, a divider control input (e.g., N) can be determined from a look-up table based on a channel indicated by the applications circuitry 2202.

Synthesizer circuitry 2206D of the RF circuitry 2206 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 2206D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 2206 can include an IQ/polar converter.

FEM circuitry 2208 can include a receive signal path which can include circuitry configured to operate on RF signals received from one or more antennas 2210, amplify the received signals and provide the amplified versions of the received signals to the RF circuitry 2206 for further processing. FEM circuitry 2208 can also include a transmit signal path which can include circuitry configured to amplify signals for transmission provided by the RF circuitry 2206 for transmission by one or more of the one or more antennas 2210. In various implementations, the amplification through the transmit or receive signal paths can be done solely in the RF circuitry 2206, solely in the FEM circuitry 2208, or in both the RF circuitry 2206 and the FEM circuitry 2208.

In some implementations, the FEM circuitry 2208 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 2206). The transmit signal path of the FEM circuitry 2208 can include a power amplifier (PA) to amplify input RF signals (e.g., provided by RF circuitry 2206), and one or more filters to generate RF signals for subsequent transmission (e.g., by one or more of the one or more antennas 2210).

In some implementations, the PMC 2212 can manage power provided to the baseband circuitry 2204. In particular, the PMC 2212 can control power-source selection, voltage scaling, battery charging, or DC-to-DC conversion. The PMC 2212 can often be included when the device 2200 is capable of being powered by a battery, for example, when the device is included in a UE. The PMC 2212 can increase the power conversion efficiency while providing desirable implementation size and heat dissipation characteristics.

While FIG. 22 shows the PMC 2212 coupled only with the baseband circuitry 2204. However, in other implementations, the PMC 2212 can be additionally or alternatively coupled with, and perform similar power management operations for, other components such as, but not limited to, application circuitry 2202, RF circuitry 2206, or FEM circuitry 2208.

In some implementations, the PMC 2212 can control, or otherwise be part of, various power saving mechanisms of the device 2200. For example, if the device 2200 is in an RRC_Connected state, where it is still connected to the RAN node as it expects to receive traffic shortly, then it can enter a state known as Discontinuous Reception Mode (DRX) after a period of inactivity. During this state, the device 2200 can power down for brief intervals of time and thus save power.

If there is no data traffic activity for an extended period of time, then the device 2200 can transition off to an RRC_Idle state, where it disconnects from the network and does not perform operations such as channel quality feedback, handover, etc. The device 2200 goes into a very low power state and it performs paging where again it periodically wakes up to listen to the network and then powers down again. The device 2200 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 2202 and processors of the baseband circuitry 2204 can be used to execute elements of one or more instances of a protocol stack. For example, processors of the baseband circuitry 2204, alone or in combination, can be used execute Layer 3, Layer 2, or Layer 1 functionality, while processors of the baseband circuitry 2204 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer I can comprise a physical (PHY) layer of a UE/RAN node, described in further detail below.

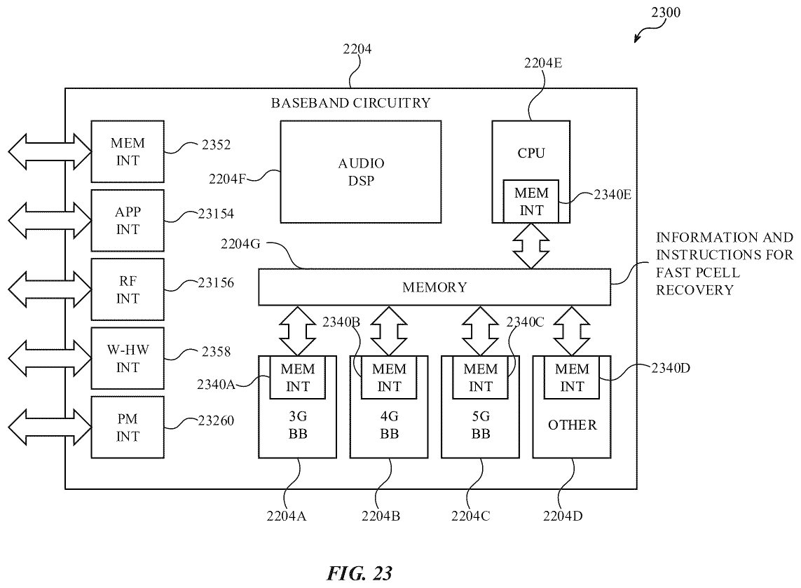

FIG. 23 is a diagram of example interfaces 2300 of baseband circuitry according to one or more implementations described herein. As discussed above, the baseband circuitry 2204 of FIG. 22 can comprise processors 2204A through 2204E and a memory 2204G utilized by said processors. Each of the processors 2204A through 2204E can include a memory interface, 2340A through 2340E, respectively, to send/receive data to/from the memory 2204G.

In some implementations, memory 2204G can receive, store, and/or provide information and instructions for enabling fast PCell recovery using an SuC 222-3 to configure the new PCell and restore a failed radio link between a UE 210 and a previous PCell 222-1. UE 210 can have a first radio link with a PCell 222-1 and a second radio link with a SuC 222-3. UE 210 can detect an RLF corresponding to the PCell 222-2, and in response to the failure, can use the SuC 222-3 to recover connectivity. That is, UE 210 can send PCell failure information to the SuC 222-3 and, in response to the PCell failure information, the network can configure another cell to operate as a new PCell for the UE. Depending on the scenario, the new PCell can be an SpCell configured with PCell configuration information, the SuC 222-3 configured with PCell configuration information, or another type of cell (e.g., SpCell 222-4). The new PCell and UE 210 can then communicate with one another to establish a new radio link to replace the failed radio link. These and many other features and examples are described herein.

The baseband circuitry 2204 can further include one or more interfaces to communicatively couple to other circuitries/devices, such as a memory interface 2252 (e.g., an interface to send/receive data to/from memory external to the baseband circuitry 2204), an application circuitry interface 2354 (e.g., an interface to send/receive data to/from the application circuitry 2202 of FIG. 22), an RF circuitry interface 2356 (e.g., an interface to send/receive data to/from RF circuitry 2206 of FIG. 22), a wireless hardware connectivity interface 2358 (e.g., an interface to send/receive data to/from Near Field Communication (NFC) components, Bluetooth® components (e.g., Bluetooth® Low Energy), Wi-Fi® components, and other communication components), and a power management interface 2360 (e.g., an interface to send/receive power or control signals to/from the PMC 2212).

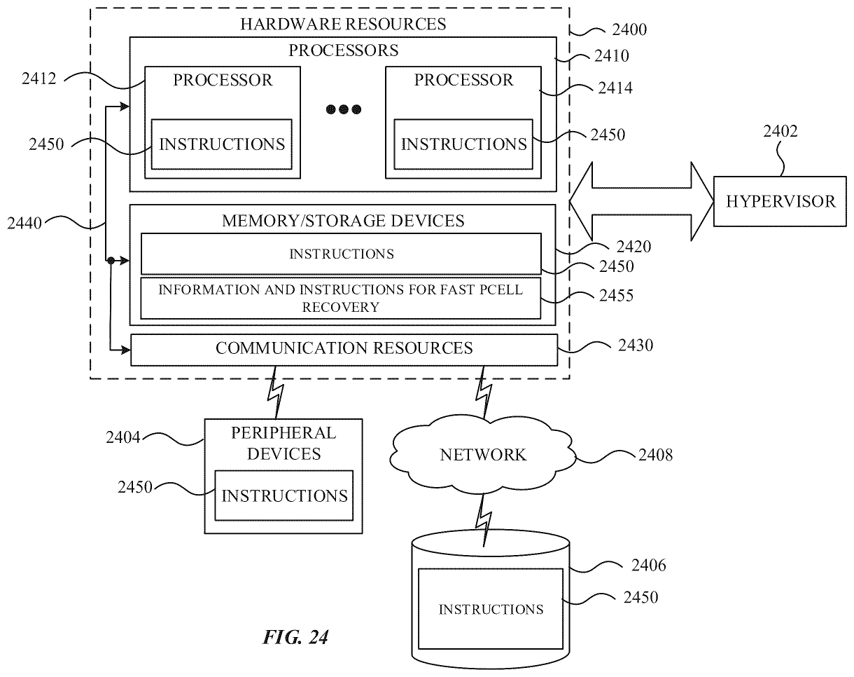

FIG. 24 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 24 shows a diagrammatic representation of hardware resources 2400 including one or more processors (or processor cores) 2410, one or more memory/storage devices 2420, and one or more communication resources 2430, each of which can be communicatively coupled via a bus 2440. For implementations where node virtualization (e.g., NFV) is utilized, a hypervisor can be executed to provide an execution environment for one or more network slices/sub-slices to utilize the hardware resources 2400.

The processors 2410 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 2412 and a processor 2414.

The memory/storage devices 2420 can include main memory, disk storage, or any suitable combination thereof. The memory/storage devices 2420 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 2420 receive, store, and/or provide information and instructions 2455 for enabling fast PCell recovery using an SuC 222-3 to configure the new PCell and restore a failed radio link between a UE 210 and a previous PCell 222-1. UE 210 can have a first radio link with a PCell 222-1 and a second radio link with a SuC 222-3. UE 210 can detect an RLF corresponding to the PCell 222-2, and in response to the failure, can use the SuC 222-3 to recover connectivity. That is, UE 210 can send PCell failure information to the SuC 222-3 and, in response to the PCell failure information, the network can configure another cell to operate as a new PCell for the UE. Depending on the scenario, the new PCell can be an SpCell configured with PCell configuration information, the SuC 222-3 configured with PCell configuration information, or another type of cell (e.g., SpCell 222-4). The new PCell and UE 210 can then communicate with one another to establish a new radio link to replace the failed radio link. These and many other features and examples are described herein.

The communication resources 2430 can include interconnection or network interface components or other suitable devices to communicate with one or more peripheral devices 2404 or one or more databases 2406 via a network 2408. For example, the communication resources 2430 can include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 2450 can comprise software, a program, an application, an applet, an app, or other executable code for causing at least any of the processors 2410 to perform any one or more of the methodologies discussed herein. The instructions 2450 can reside, completely or partially, within at least one of the processors 2410 (e.g., within the processor's cache memory), the memory/storage devices 2420, or any suitable combination thereof. Furthermore, any portion of the instructions 2450 can be transferred to the hardware resources 2400 from any combination of the peripheral devices 2404 or the databases 2406. Accordingly, the memory of processors 2410, the memory/storage devices 2420, the peripheral devices 2404, and the databases 2406 are examples of computer-readable and machine-readable media.

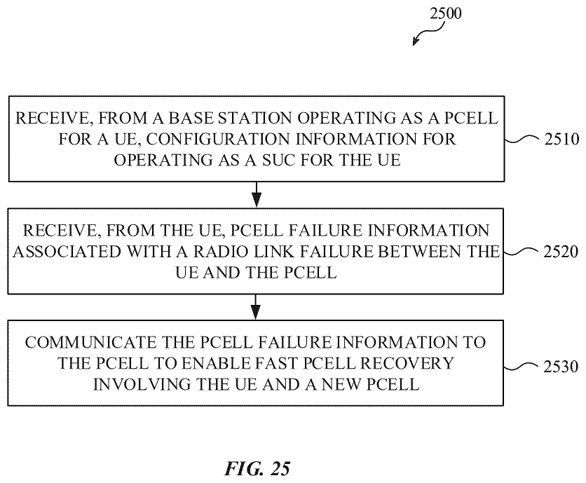

FIG. 25 is a diagram of an example of another process 2500 for fast PCell recovery according to one or more implementations described herein. Process 2500 can be implemented by base station 222 operating as an SuC for UE 210. In some implementations, some or all of process 2500 can be performed by one or more other systems or devices, including one or more of the systems or devices of FIGS. 2-6. Additionally, process 2500 can include one or more fewer, additional, differently ordered and/or arranged operations than those shown in FIG. 25. Some or all of the operations of process 2500 can be performed independently, successively, simultaneously, etc., of one or more of the other operations of process 2500. Further, one or more of the operations of process 2500 can include one or more of the features, conditions, information, characteristics, etc., described elsewhere herein. As such, the techniques described herein are not limited to the number, sequence, arrangement, timing, type, etc., of the operations or processes depicted in FIG. 25.

As shown, process 2500 can include receiving, from a base station operating as a PCell for a UE, configuration information for operating as a SuC for the UE (block 2510). Process 2500 can also include receiving, from the UE, PCell failure information associated with a radio link failure between the UE and the PCell (block 2520). Process 2500 can include communicate the PCell failure information to the PCell to enable fast PCell recovery involving the UE and a new PCell (block 2530).

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, baseband circuitry can comprise a memory; and one or more processors configured to, when executing instructions stored in the memory, cause the baseband circuitry to: establish, via radio frequency (RF) circuitry, a primary radio link corresponding to a primary cell (PCell); detect a radio link failure (RLF) corresponding to the primary radio link; generate PCell failure information in response to the RLF; send the PCell failure information to an interface with the RF circuitry for transmission to a base station; and establish, via the RF circuitry, a connection with a new PCell in response to sending the PCell failure information.

In example 2, which can also include one or more of the examples described herein, the connection with the new PCell is established based on information received from a supplementary cell (SuC).

In example 3, which can also include one or more of the examples described herein, the one or more processors is further configured to cause the baseband circuitry to: generate a request for fast PCell recovery; and receive a configuration grant for a supplementary cell (SuC) in response to the request for fast PCell recovery.

In example 4, which can also include one or more of the examples described herein, the PCell failure information is communicated to the SuC in accordance with the configuration grant.

In example 5, which can also include one or more of the examples described herein, the one or more processors is further configured to cause the baseband circuitry to: perform a random access channel (RACH) procedure involving a supplementary cell (SuC), and the PCell failure information is communicated to the SuC during the RACH procedure.

In example 6, which can also include one or more of the examples described herein, the one or more processors is further configured to cause the baseband circuitry to: receive, from the SuC, an indication that the SuC is to be the new PCell; and establish the connection with the new PCell by modifying a protocol stack associated with the SuC.

In example 7, which can also include one or more of the examples described herein, the one or more processors is further configured to cause the baseband circuitry to: receive, from the SuC, radio resource control (RRC) reconfiguration information indicating that a special cell (SpCell) is to be the new PCell; and establish the connection with the new PCell by performing a handover procedure.

In example 8, which can also include one or more of the examples described herein, the one or more processors is further configured to cause the baseband circuitry to: measure a signal strength associated with a supplementary cell (SuC) and a signal quality associated with a secondary cell (SCell); evaluate the signal quality associated with the SuC relative to signal quality associate with the SCell; and determine to send the PCell failure information to the SuC or the SCell based on an evaluation of the signal quality associated with the SuC and the signal quality associate with the SCell.

In example 9, which can also include one or more of the examples described herein, the one or more processors is further configured to cause the baseband circuitry to: receive, from the SuC or the SCell, an indication that the SuC or the SCell is to be the new PCell; and establish the connection with the new PCell by modifying a protocol stack associated with the SuC.

In example 10, which can also include one or more of the examples described herein, the one or more processors is further configured to cause the baseband circuitry to: receive, from the SuC or the SCell, radio resource control (RRC) reconfiguration information indicating that a special cell (SpCell) is to be the new PCell; and establish the connection with the new PCell by performing a handover procedure.

In example 11, which can also include one or more of the examples described herein, the one or more processors is further configured to cause the baseband circuitry to: identify a target cell as the new PCell based on a measured signal strength the target cell relative a measured signal strength of at least one other neighboring cell; and establish the connection with the new PCell by performing a radio resource control (RRC) reestablishment procedure involving the target cell.

In example 12, which can also include one or more of the examples described herein, a base station, operating as a primary cell (PCell) can comprise: a memory; and one or more processors configured to, when executing instructions stored in the memory, cause the base station to: receive, from a user equipment (UE), a request for fast PCell recovery services; configure a supplementary cell (SuC) for the fast PCell recovery services; receive, from the SuC, PCell failure information associated with the UE; determine, based on the PCell failure information, a new PCell for the UE; and configure the new PCell to operate as the new PCell for the UE.

In example 13, which can also include one or more of the examples described herein, the PCell failure information comprises at an indication of a link quality between the UE and at least one neighboring cell.

In example 14, which can also include one or more of the examples described herein, the new PCell comprises at least one of: the SuC of the UE, a secondary (SCell) of the UE, and a neighboring cell other than the SuC or the SCell.

In example 15, which can also include one or more of the examples described herein, the one or more processors is further configured to cause the base station to: determine, based on a radio link quality between the UE and the SuC, that the SuC is to be the new PCell; and configure the SuC with at least one signaling radio bearer (SRB) and radio link monitoring (RLM) for communicating with the UE as the new PCell.

In example 16, which can also include one or more of the examples described herein, the one or more processors is further configured to cause the base station to: determine, based on a radio link quality between the UE and the SuC, that a neighboring cell other than the SuC is to be the new PCell; and configure the new PCell to become the new PCell via a handover procedure with the UE.

In example 17, which can also include one or more of the examples described herein, the one or more processors is further configured to cause the base station to: determine, based on the PCell failure information, a plurality of target cells; communicate a UE context to the plurality of target cells; receive an acknowledgement of the UE context from the plurality of target cells; receive a UE context release from the new PCell, wherein the new PCell comprises a target cell of the plurality of target cells; and communicate UE context release the plurality of target cells other than the PCell.

In example 18, which can also include one or more of the examples described herein, a base station can comprise: a memory; and one or more processors configured to, when executing instructions stored in the memory, cause the base station to: receive, from a base station operating as a primary cell (PCell) for a user equipment (UE), configuration information for operating as a supplementary cell (SuC) for the UE; receive, from the UE, PCell failure information associated with a radio link failure between the UE and the PCell; and communicate the PCell failure information to the PCell to enable fast PCell recovery involving the UE and a new PCell.

In example 19, which can also include one or more of the examples described herein, the one or more processors is further configured to cause the base station to: receive, from the PCell, configuration information for operating as the new PCell for the UE; and establish a primary radio link with the UE based on the configuration information.

In example 20, which can also include one or more of the examples described herein, the one or more processors is further configured to cause the base station to: communicate, the UE, radio resource control (RRC) reconfiguration information for a handover procedure involving the UE and a special cell (SpCell).

In example 21, which can also include one or more of the examples described herein, the base station is configured to communicate with the UE via supplementary uplink (SUL) and supplementary downlink (SDL) resources allocated to the UE.

In example 22, which can also include one or more of the examples described herein, the base station is configured to communicate with the UE uplink and downlink carrier aggregation (CA) resources.

In example 23, which can also include one or more of the examples described herein, a user equipment (UE) can comprise a memory; and one or more processors configured to, when executing instructions stored in the memory, cause the UE to: establish a primary radio link corresponding to a primary cell (PCell); detect a radio link failure (RLF) corresponding to the primary radio link; generate PCell failure information in response to the RLF; send the PCell failure information a supplementary cell (SuC); and establish a connection with a new PCell in response to sending the PCell failure information.

In example 24, which can also include one or more of the examples described herein, a method, performed by a user equipment (UE), can comprise: establishing a primary radio link corresponding to a primary cell (PCell); detecting a radio link failure (RLF) corresponding to the primary radio link; generating PCell failure information in response to the RLF; sending the PCell failure information a supplementary cell (SuC); and establishing a connection with a new PCell in response to sending the PCell failure information.

In example 25, which can also include one or more of the examples described herein, a method, performed by a base station, the method comprising: receiving, from a user equipment (UE), a request for fast PCell recovery services; configuring a supplementary cell (SuC) for the fast PCell recovery services; receiving, from the SuC, PCell failure information associated with the UE; determining, based on the PCell failure information, a new PCell for the UE; and configuring the new PCell to operate as the new PCell for the UE.

In example 26, which can also include one or more of the examples described herein, a method, performed by a base station, can comprise: receiving, from a base station operating as a primary cell (PCell) for a user equipment (UE), configuration information for operating as a supplementary cell (SuC) for the UE; receiving, from the UE, PCell failure information associated with a radio link failure between the UE and the PCell; and communicating the PCell failure information to the PCell to enable fast PCell recovery involving the UE and a new PCell.

The examples discussed above also extend to method, computer-readable medium, and means-plus-function claims and implementations, an of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. Baseband circuitry, comprising:
a memory; and
one or more processors configured to, when executing instructions stored in the memory, cause the baseband circuitry to:
establish, via radio frequency (RF) circuitry, a primary radio link corresponding to a primary cell (PCell);
detect a radio link failure (RLF) corresponding to the primary radio link;
generate PCell failure information in response to the RLF;
send the PCell failure information to an interface with the RF circuitry for transmission to a base station; and
establish, via the RF circuitry, a connection with a new PCell in response to sending the PCell failure information.

2. The baseband circuitry of claim 1, wherein the connection with the new PCell is established based on information received from a supplementary cell (SuC).

3. The baseband circuitry of claim 2, wherein the one or more processors is further configured to cause the baseband circuitry to:
generate a request for fast PCell recovery; and
receive a configuration grant for a supplementary cell (SuC) in response to the request for fast PCell recovery.

4. The baseband circuitry of claim 3, wherein the PCell failure information is communicated to the SuC in accordance with the configuration grant.

5. The baseband circuitry of claim 2, wherein:
the one or more processors is further configured to cause the baseband circuitry to:
perform a random access channel (RACH) procedure involving a supplementary cell (SuC), and
the PCell failure information is communicated to the SuC during the RACH procedure.

6. The baseband circuitry of claim 2, wherein the one or more processors is further configured to cause the baseband circuitry to:
receive, from the SuC, an indication that the SuC is to be the new PCell; and
establish the connection with the new PCell by modifying a protocol stack associated with the SuC.

7. The baseband circuitry of claim 2, wherein the one or more processors is further configured to cause the baseband circuitry to:
receive, from the SuC, radio resource control (RRC) reconfiguration information indicating that a special cell (SpCell) is to be the new PCell; and
establish the connection with the new PCell by performing a handover procedure.

8. The baseband circuitry of claim 1, wherein the one or more processors is further configured to cause the baseband circuitry to:
measure a signal strength associated with a supplementary cell (SuC) and a signal quality associated with a secondary cell (SCell);
evaluate the signal quality associated with the SuC relative to signal quality associate with the SCell; and
determine to send the PCell failure information to the SuC or the SCell based on an evaluation of the signal quality associated with the SuC and the signal quality associate with the SCell.

9. The baseband circuitry of claim 8, wherein the one or more processors is further configured to cause the baseband circuitry to:
receive, from the SuC or the SCell, an indication that the SuC or the SCell is to be the new PCell; and
establish the connection with the new PCell by modifying a protocol stack associated with the SuC.

10. The baseband circuitry of claim 8, wherein the one or more processors is further configured to cause the baseband circuitry to:
receive, from the SuC or the SCell, radio resource control (RRC) reconfiguration information indicating that a special cell (SpCell) is to be the new PCell; and
establish the connection with the new PCell by performing a handover procedure.

11. The baseband circuitry of claim 1, wherein the one or more processors is further configured to cause the baseband circuitry to:
identify a target cell as the new PCell based on a measured signal strength the target cell relative a measured signal strength of at least one other neighboring cell; and
establish the connection with the new PCell by performing a radio resource control (RRC) reestablishment procedure involving the target cell.

12. A base station, operating as a primary cell (PCell), comprising:
a memory; and
one or more processors configured to, when executing instructions stored in the memory, cause the base station to:
receive, from a user equipment (UE), a request for fast PCell recovery services;
configure a supplementary cell (SuC) for the fast PCell recovery services;
receive, from the SuC, PCell failure information associated with the UE;
determine, based on the PCell failure information, a new PCell for the UE; and
configure the new PCell to operate as the new PCell for the UE.

13. The base station of claim 12, wherein the PCell failure information comprises at an indication of a link quality between the UE and at least one neighboring cell.

14. The base station of claim 13, wherein the new PCell comprises at least one of:
the SuC of the UE,
a secondary (SCell) of the UE, and
a neighboring cell other than the SuC or the SCell.

15. The base station of claim 12, wherein the one or more processors is further configured to cause the base station to:
determine, based on a radio link quality between the UE and the SuC, that the SuC is to be the new PCell; and
configure the SuC with at least one signaling radio bearer (SRB) and radio link monitoring (RLM) for communicating with the UE as the new PCell.

16. The base station of claim 12, wherein the one or more processors is further configured to cause the base station to:
determine, based on a radio link quality between the UE and the SuC, that a neighboring cell other than the SuC is to be the new PCell; and
configure the new PCell to become the new PCell via a handover procedure with the UE.

17. The base station of claim 12, wherein the one or more processors is further configured to cause the base station to:
determine, based on the PCell failure information, a plurality of target cells;
communicate a UE context to the plurality of target cells;
receive an acknowledgement of the UE context from the plurality of target cells;
receive a UE context release from the new PCell, wherein the new PCell comprises a target cell of the plurality of target cells; and
communicate UE context release the plurality of target cells other than the PCell.

18. A base station, comprising:
a memory; and
one or more processors configured to, when executing instructions stored in the memory, cause the base station to:
receive, from a base station operating as a primary cell (PCell) for a user equipment (UE), configuration information for operating as a supplementary cell (SuC) for the UE;
receive, from the UE, PCell failure information associated with a radio link failure between the UE and the PCell; and
communicate the PCell failure information to the PCell to enable fast PCell recovery involving the UE and a new PCell.

19. The base station of claim 18, wherein the one or more processors is further configured to cause the base station to:
receive, from the PCell, configuration information for operating as the new PCell for the UE; and
establish a primary radio link with the UE based on the configuration information.

20. The base station of claim 18, wherein the one or more processors is further configured to cause the base station to:
communicate, the UE, radio resource control (RRC) reconfiguration information for a handover procedure involving the UE and a special cell (SpCell).
